(19) United States
(12) Patent Application Publication
(10) Pub. No.: US 2017/0153364 A1
(43) Pub. Date: Jun. 1, 2017

(54) LIGHT DIFFUSION MEMBER, METHOD FOR PRODUCING SAME, AND DISPLAY DEVICE

(71) Applicants: Toru KANNO, Osaka-shi (JP); Tsuyoshi MAEDA, Osaka-shi (JP); Emi YAMAMOTO, Osaka-shi (JP)

(72) Inventors: Toru KANNO, Osaka-shi (JP); Tsuyoshi MAEDA, Osaka-shi (JP); Emi YAMAMOTO, Osaka-shi (JP)

(73) Assignee: Sharp Kabushiki Kaisha, Osaka-shi, Osaka (JP)

(21) Appl. No.: 14/116,812

(22) PCT Filed: May 10, 2012
(86) PCT No.: PCT/JP2012/061988

§ 371 Date: Nov. 11, 2013

(30) Foreign Application Priority Data
May 13, 2011 (JP) 2011-108708

(51) Int. Cl. G02B 5/02; F21V 8/00; G02F 1/1335; G02B 5/30

(52) U.S. Cl. CPC G02B 5/0263; G02B 5/0242; G02B 5/0268; G02B 5/0278; G02B 5/3083; G02B 6/0051; G02F 1/133606

(57) ABSTRACT

A light diffusion member includes a light transmissive substrate, a plurality of light diffusion sections, a light shielding layer, and a bonding layer. The plurality of light diffusion sections are disposed in first regions on one surface of the substrate. The light shielding layer is disposed in a second region which is other than the first regions on the one surface of the substrate. The bonding layer is disposed so as to overlap with the plurality of light diffusion sections. Each of the light diffusion sections is formed such that one surface side of the substrate forms a light emitting end surface, a surface facing the light emitting end surface forms a light incident end surface, and a cross-sectional area of each of the light diffusion sections is increased from the light emitting end surface toward the light incident end surface. A plurality of light scattering bodies which are formed of a material having a refractive index which is different from a refractive index of a constituent material of the light diffusion sections or a constituent material of the bonding layer are dispersively disposed in at least one side among the light diffusion sections and the bonding layer.

### TECHNICAL FIELD

The present invention relates to a light diffusion member, a method for producing the same, and a display device.

This application claims priority based on Japanese Patent Application No. 2011-108708 filed on May 13, 2011 in Japan, the disclosure of which is incorporated herein by reference.

### BACKGROUND ART

Liquid crystal display devices have been widely used as displays of portable electronic devices such as mobile phones, television sets, personal computers, or the like. However, it has been known that the liquid crystal display devices are generally excellent in viewability from the front, whereas the viewing angle thereof is narrow, so various attempts for widening the viewing angle have been made. As one of these attempts, a configuration is considered in which a member (hereinafter, referred to as a light diffusion member) which diffuses light emitted from a display body such as a liquid crystal panel is provided on a viewing side of the display body.

For example, PTL 1 below discloses a viewing angle widening film including a sheet body, and a plurality of substantially wedge-shaped portions which are embedded on an emitting surface side within the seat body and extend toward the emitting surface side. In the viewing angle widening film, a side surface of each of the substantially wedge-shaped portions is formed of bend surfaces, and an angle formed by each bend surface of the side surface and a line perpendicular to an incident surface becomes larger toward the emitting surface side. By forming the side surface of the substantially wedge-shaped portions in this manner, the viewing angle widening film causes light incident perpendicularly on the incident surface to be totally reflected on the side surface a plurality of times and thus increases the diffusion angle.

### CITATION LIST

### Patent Literature

PTL 1: Japanese Unexamined Patent Application Publication No. 2005-157216

### SUMMARY OF INVENTION

### Technical Problem

When producing the viewing angle widening film described in PTL 1, it is difficult to form the substantially wedge-shaped portions having side surfaces formed of a plurality of bend surfaces in the seat body. Further, after forming the substantially wedge-shaped portions in the seat body, embedding UV curable resins in the substantially wedge-shaped portions without a gap is not a simple procedure, and the manufacturing process becomes complicated. If, for example, the inclination angle of the bend surface cannot be formed accurately, or the resin is not sufficiently embedded in the substantially wedge-shaped portions, a desired light diffusion property may not be obtained.

An aspect of the present invention has been made to solve the problems described above, and an object of the present invention is to provide a light diffusion member and a method for producing the same by which a desired light diffusion property can be obtained without complicating manufacturing processes. In addition, another object is to provide a display device which includes the light diffusion member described above and is excellent in display quality.

### Solution to Problem

In order to solve the above problems, some aspects of the present invention provide a light diffusion member, a method for producing the same, and a display device as follows.

In other words, a light diffusion member according to an aspect of the present invention includes a light transmissive substrate; a plurality of light diffusion sections disposed in first regions on one surface of the substrate; a light shielding layer disposed in a second region which is other than the first regions on the one surface of the substrate; and a bonding layer disposed so as to overlap with the plurality of light diffusion sections, in which each of the light diffusion sections is formed such that one surface side of the substrate forms a light emitting end surface, a surface facing the light emitting end surface forms a light incident end surface, and a cross-sectional area of each of the light diffusion sections is increased from the light emitting end surface toward the light incident end surface, and in which a plurality of light scattering bodies are dispersively disposed in at least one side among the light diffusion sections and the bonding layer, each light scattering body being formed of a material having a refractive index which is different from a refractive index of a constituent material of the light diffusion sections or a constituent material of the bonding layer.

The light diffusion sections may be formed such that the dimension thereof between the light emitting end surface and the light incident end surface is larger than the thickness of the light shielding layer.

The plurality of light diffusion sections may be arranged in stripes at a distance from one another as viewed from a normal direction of the one surface of the substrate, and the light shielding layer may be disposed as a stripe between the light diffusion sections arranged in stripes at a distance from one another as viewed from the normal direction of the one surface of the substrate.

At least one of the dimension of the plurality of light diffusion sections in a lateral direction and the dimension of a plurality of the light shielding layers in a lateral direction may be set randomly.

The plurality of light diffusion sections may be scatteringly disposed on the one surface of the substrate, and the light shielding layer may be formed continuously in the second region.

The plurality of light diffusion sections may have the same cross-sectional shape to each other and be regularly arranged on the one surface of the substrate.

The plurality of light diffusion sections may have the same cross-sectional shape to each other and be irregularly scattered on the one surface of the substrate.

The plurality of light diffusion sections may have cross-sectional shapes of different types from each other and be irregularly scattered on the one surface of the substrate.

Cross-sectional shapes of the plurality of light diffusion sections may be circular, elliptical, and polygonal.

A light diffusion member according to another aspect of the present invention includes a light transmissive substrate; a plurality of light shielding layers disposed in first regions on one surface of the substrate; and a light diffusion section disposed in a second region which is other than the first regions on the one surface of the substrate; in which each light diffusion section is formed such that one surface side of the substrate forms a light emitting end surface, a surface facing the light emitting end surface forms a light incident end surface, and the dimension of each light diffusion section between the light emitting end surface and the light incident end surface is larger than the thickness of the light shielding layers, in which hollow portions are formed in formation regions of the light shielding layers, a sectional area of each hollow portion decreasing in a direction away from the light shielding layers, and each hollow portion being partitioned by a formation region of the light diffusion section, and in which a plurality of light scattering bodies are dispersively disposed in the light diffusion section, each light scattering body being formed of a material having a refractive index which is different from a refractive index of a constituent material of the light diffusion section.

The plurality of light shielding layers may be scatteringly disposed on the one surface of the substrate, and the light diffusion section may be formed continuously so as to surround the light shielding layers.

The hollow portions may have the same cross-sectional shape to each other and be regularly arranged on the one surface of the substrate.

The hollow portions may have the same cross-sectional shape to each other and be irregularly scattered on the one surface of the substrate.

The hollow portions may have cross-sectional shapes of a plurality of different types from each other and be irregularly scattered on the one surface of the substrate.

A display device of the present invention includes one of the light diffusion members described above; and a display body which is bonded to the light diffusion member through the bonding layer.

The display body may include a plurality of pixels forming a display image, and the light diffusion sections may be disposed such that a maximum pitch between the light diffusion sections which are adjacent to each other is smaller than the pitch between the pixels of the display body.

The display body may include a light source and an optical modulation element which modulates light from the light source, and the light source may emit light having directivity.

The display body may be a liquid crystal display element.

A method for producing a light diffusion member according to still another aspect of the present invention includes forming a light shielding layer on a substrate; forming openings, through which the substrate is exposed, in the light shielding layer; and forming, for the openings, a light diffusion section in which a plurality of light scattering bodies are dispersively disposed by using the light shielding layer as a mask.

Any one of black resins, black inks, metals, or multilayer films including metals and metal oxides may be used as the light shielding layer.

### Advantageous Effects of Invention

According to the aspects of the present invention, it is possible to provide a display device including the light diffusion member described above and having excellent display quality. According to the present invention, it is possible to provide a light diffusion member and a method for producing the same capable of obtaining a desired light diffusion property without complicating manufacturing processes.

### BRIEF DESCRIPTION OF DRAWINGS

FIG. 1 is a perspective view showing a liquid crystal display device of a first embodiment.

FIG. 2 is a cross-sectional view of the liquid crystal display device.

FIG. 3 is a cross-sectional view of a liquid crystal panel of the liquid crystal display device.

FIG. 4A is a perspective view showing a manufacturing process of a viewing angle widening film of the liquid crystal display device.

FIG. 4B is a perspective view showing a manufacturing process of the viewing angle widening film of the liquid crystal display device.

FIG. 4C is a perspective view showing a manufacturing process of the viewing angle widening film of the liquid crystal display device.

FIG. 4D is a perspective view showing a manufacturing process of the viewing angle widening film of the liquid crystal display device.

FIG. 4E is a perspective view showing a manufacturing process of the viewing angle widening film of the liquid crystal display device.

FIG. 5A is a schematic diagram for explaining an operation of the viewing angle widening film.

FIG. 5B is a schematic diagram for explaining an operation of the viewing angle widening film.

FIG. 6 is a perspective view showing a modification example of the first embodiment.

FIG. 7 is a cross-sectional view of the liquid crystal display device of a second embodiment.

FIG. 8 is a cross-sectional view of the liquid crystal display device.

FIG. 9A is a perspective view showing a manufacturing process of a viewing angle widening film of the liquid crystal display device.

FIG. 9B is a perspective view showing a manufacturing process of the viewing angle widening film of the liquid crystal display device.

FIG. 9C is a perspective view showing a manufacturing process of the viewing angle widening film of the liquid crystal display device.

FIG. 9D is a perspective view showing a manufacturing process of the viewing angle widening film of the liquid crystal display device.

FIG. 9E is a perspective view showing a manufacturing process of the viewing angle widening film of the liquid crystal display device.

FIG. 10A is a perspective view showing a modification example of the first embodiment.

FIG. 10B is a cross-sectional view showing the modification example of the first embodiment.

FIG. 11 is a perspective view showing a liquid crystal display device of a third embodiment.

FIG. 12 is a cross-sectional view of the liquid crystal display device.

FIG. 13A is a perspective view showing a manufacturing process of a viewing angle widening film of the liquid crystal display device.

FIG. 13B is a perspective view showing a manufacturing process of the viewing angle widening film of the liquid crystal display device.

FIG. 13C is a perspective view showing a manufacturing process of the viewing angle widening film of the liquid crystal display device.

FIG. 13D is a perspective view showing a manufacturing process of the viewing angle widening film of the liquid crystal display device.

FIG. 13E is a perspective view showing a manufacturing process of the viewing angle widening film of the liquid crystal display device.

FIG. 14A is a schematic diagram for explaining an operation of the viewing angle widening film.

FIG. 14B is a schematic diagram for explaining an operation of the viewing angle widening film.

FIG. 15A is a plane view showing another example of a light diffusion section in a viewing angle widening film.

FIG. 15B is a plane view showing another example of a light diffusion section in a viewing angle widening film.

FIG. 15C is a plane view showing another example of a light diffusion section in a viewing angle widening film.

FIG. 15D is a plane view showing another example of a light diffusion section in a viewing angle widening film.

FIG. 15E is a plane view showing another example of a light diffusion section in a viewing angle widening film.

FIG. 15F is a plane view showing another example of a light diffusion section in a viewing angle widening film.

FIG. 16A is a schematic diagram for explaining an operation of the viewing angle widening film of another example.

FIG. 16B is a schematic diagram for explaining an operation of the viewing angle widening film of another example.

FIG. 17A is a cross-sectional view showing a modification example of the third embodiment.

FIG. 17B is a perspective view showing the modification example of the third embodiment.

FIG. 18 is a perspective view showing a liquid crystal display device of a fourth embodiment.

FIG. 19 is a cross-sectional view of the liquid crystal display device.

FIG. 20A is a perspective view showing a manufacturing process of a viewing angle widening film of the liquid crystal display device.

FIG. 20B is a perspective view showing a manufacturing process of the viewing angle widening film of the liquid crystal display device.

FIG. 20C is a perspective view showing a manufacturing process of the viewing angle widening film of the liquid crystal display device.

FIG. 20D is a perspective view showing a manufacturing process of the viewing angle widening film of the liquid crystal display device.

FIG. 20E is a perspective view showing a manufacturing process of the viewing angle widening film of the liquid crystal display device.

FIG. 21 is a perspective view showing a modification example of the fourth embodiment.

FIG. 22 is a perspective view showing a liquid crystal display device of a fifth embodiment.

FIG. 23 is a cross-sectional view of the liquid crystal display device.

FIG. 24 is a schematic diagram for explaining an operation of a viewing angle widening film.

FIG. 25A is a perspective view showing a manufacturing process of a viewing angle widening film of the liquid crystal display device.

FIG. 25B is a perspective view showing a manufacturing process of the viewing angle widening film of the liquid crystal display device.

FIG. 25C is a perspective view showing a manufacturing process of the viewing angle widening film of the liquid crystal display device.

FIG. 25D is a perspective view showing a manufacturing process of the viewing angle widening film of the liquid crystal display device.

FIG. 26A is a plane view showing a shape example of a light shielding layer.

FIG. 26B is a plane view showing a shape example of the light shielding layer.

FIG. 26C is a plane view showing a shape example of the light shielding layer.

FIG. 26D is a plane view showing a shape example of the light shielding layer.

FIG. 26E is a plane view showing a shape example of the light shielding layer.

FIG. 26F is a plane view showing a shape example of the light shielding layer.

FIG. 26G is a plane view showing a shape example of the light shielding layer.

FIG. 26H is a plane view showing a shape example of the light shielding layer.

FIG. 26I is a plane view showing a shape example of the light shielding layer.

FIG. 26J is a plane view showing a shape example of the light shielding layer.

FIG. 27 is a cross-sectional view showing a modification example of the fifth embodiment.

FIG. 28 is a perspective view showing a liquid crystal display device of a sixth embodiment.

FIG. 29A is a perspective view showing a manufacturing process of a viewing angle widening film of the liquid crystal display device.

FIG. 29B is a perspective view showing a manufacturing process of the viewing angle widening film of the liquid crystal display device.

FIG. 29C is a perspective view showing a manufacturing process of the viewing angle widening film of the liquid crystal display device.

FIG. 29D is a perspective view showing a manufacturing process of the viewing angle widening film of the liquid crystal display device.

FIG. 30A is a diagram showing an arrangement of a light shielding layer.

FIG. 30B is a diagram showing an arrangement of the light shielding layer.

FIG. 30C is a diagram showing an arrangement of the light shielding layer.

FIG. 31 is a perspective view showing a liquid crystal display device of a seventh embodiment.

FIG. 32A is a perspective view showing a manufacturing process of a viewing angle widening film of the liquid crystal display device.

FIG. 32B is a perspective view showing a manufacturing process of the viewing angle widening film of the liquid crystal display device.

FIG. 32C is a perspective view showing a manufacturing process of the viewing angle widening film of the liquid crystal display device.

FIG. 32D is a perspective view showing a manufacturing process of the viewing angle widening film of the liquid crystal display device.

FIG. 33 is a perspective view showing a liquid crystal display device of an eighth embodiment.

FIG. 34 is a cross-sectional view of the liquid crystal display device.

FIG. 35 is a cross-sectional view showing a viewing angle widening film of the liquid crystal display device according to a manufacturing process sequence.

FIG. 36A is a cross-sectional view showing a modification example of the ninth embodiment.

FIG. 36B is a cross-sectional view showing the modification example of the ninth embodiment.

FIG. 37 is a perspective view showing a liquid crystal display device of a ninth embodiment.

FIG. 38 is a cross-sectional view of the liquid crystal display device.

FIG. 39 is a cross-sectional view showing a viewing angle widening film of the liquid crystal display device according to a manufacturing process sequence.

FIG. 40 is a schematic configuration diagram of a manufacturing apparatus used in a manufacturing process of a light diffusion section of a tenth embodiment.

FIG. 41A is a graph showing an operation of the light diffusion section.

FIG. 41B is a cross-sectional view showing an operation of the light diffusion section.

FIG. 41C is a graph showing an operation of the light diffusion section.

FIG. 42A is a cross-sectional view showing an variation of the ninth embodiment.

FIG. 42B is a cross-sectional view showing a variation of the ninth embodiment.

### DESCRIPTION OF EMBODIMENTS

Hereinafter, a light diffusion member and a method for producing the same according to an embodiment of the present invention, and an embodiment of a display device will be described with reference to the drawings. In addition, the embodiments presented below are described in detail in order to better understand the spirit of the present invention, unless otherwise specified, the following embodiments are not intended to limit the aspects of the present invention. Further, in the drawings used in the following description, there are cases where portions as main parts are enlarged and shown in order to facilitate better understanding of the features of embodiments of the present invention, for convenience, and a dimensional ratio of each component is not necessarily the same as the actual dimensional ratio.

### First Embodiment

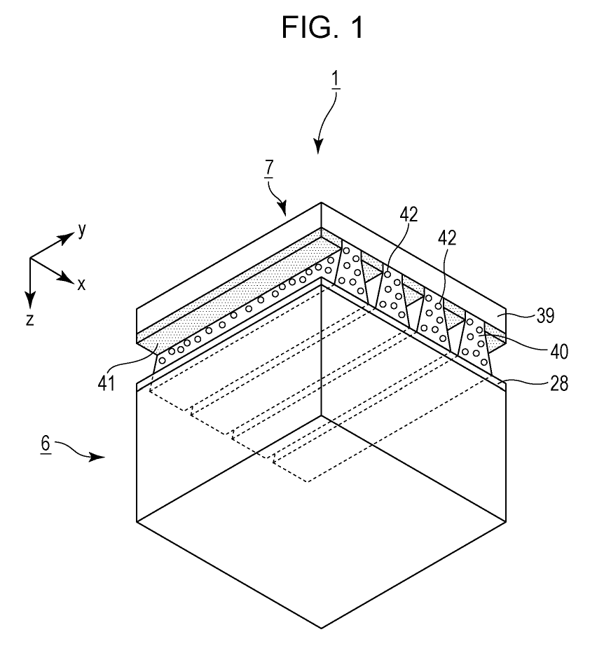

Hereinafter, a first embodiment of the present invention will be described using FIG. 1 to FIG. 5B.

In the present embodiment, an example of a liquid crystal display device including a liquid crystal panel of a transmission type as a display body is described.

Note that in all of the following drawings, for easier viewing of the respective components, the respective components may be indicated by the varying scale dimensions.

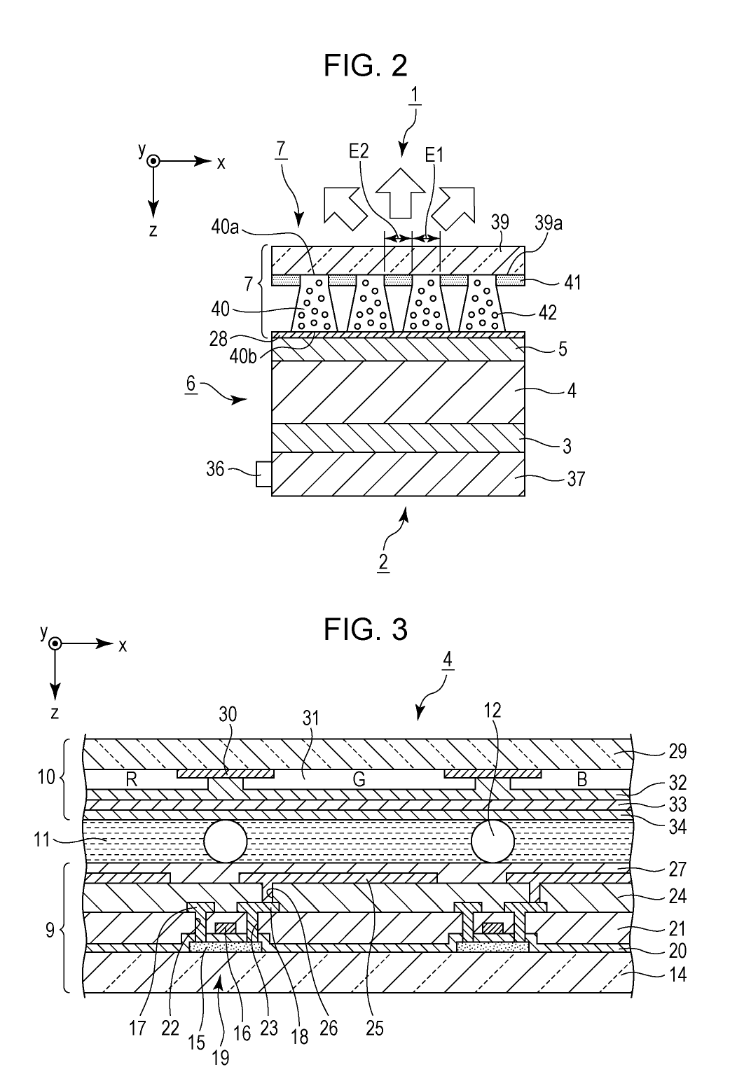

FIG. 1 is a perspective view when viewed from the obliquely downward direction (back surface side) of a liquid crystal display device including a light diffusion member of the present embodiment. FIG. 2 is a cross-sectional view of the liquid crystal display device including a light diffusion member of the present embodiment.

As shown in FIGS. 1 and 2, the liquid crystal display device 1 (display device) of the present embodiment includes a liquid crystal display body 6 (display body) including a backlight 2 (light source), a first polarizing plate 3, a liquid crystal panel 4 (light modulation element), and a second polarizing plate 5 and a light diffusion member 7 (hereinafter, referred to as a viewing angle widening film).

Although FIG. 2 schematically shows the liquid crystal panel 4 in a single plate shape, the detailed structure will be described later. In FIG. 2, observers will see the display from the top of the liquid crystal display device 1 in which the viewing angle widening film 7 is disposed, that is, from the viewing angle widening film 7. Therefore, in the following description, for the sake of convenience, the side having the viewing angle widening film 7 disposed is referred to as a viewing side, and the side having the backlight 2 disposed is referred to as a back surface side.

In the liquid crystal display device 1 of the present embodiment, the light emitted from the backlight 2 is modulated in the liquid crystal panel 4, and the modulated light is displayed as predetermined images, characters, or the like. Further, if the light emitted from the liquid crystal panel 4 is transmitted through the viewing angle widening film (the light diffusion member) 7, the light is emitted from the viewing angle widening film 7 in a state where the angular distribution of the light has become wider than before being incident on the viewing angle widening film 7. Thus, the observer can view the display with a wide viewing angle.

First, the specific configuration of the liquid crystal panel 4 will be described.

Here, although a transmissive liquid crystal panel of an active matrix type is described as an example, the liquid crystal panel applicable to the present embodiment is not limited to the transmissive liquid crystal panel of the active matrix type. The liquid crystal panel applicable to the present embodiment may be, for example, a transflective (transmission and reflection combined type) liquid crystal panel, or a reflective liquid crystal panel, and further may be a liquid crystal panel of a simple matrix type in which each pixel does not have a Thin Film Transistor (hereinafter, abbreviated as TFT) for switching.

FIG. 3 is a longitudinal cross-sectional view of the liquid crystal panel 4.

As shown in FIG. 3, the liquid crystal panel 4 includes a TFT substrate 9, a color filter substrate 10, and a liquid crystal layer 11. The TFT substrate 9 is provided on the liquid crystal panel 4 as a switching element substrate. The color filter substrate 10 is disposed to oppose the TFT substrate 9. The liquid crystal layer 11 is interposed between the TFT substrate 9 and the color filter substrate 10. The liquid crystal layer 11 is enclosed in a space surrounded by the TFT substrate 9, the color filter substrate 10, and a frame-like seal member (not shown) bonding the TFT substrate 9 and color filter substrate 10 at a predetermined interval therebetween.

The liquid crystal panel 4 of the present embodiment is intended for displaying in, for example, a Vertical Alignment (VA) mode, and vertically aligned liquid crystals having a negative dielectric anisotropy are used in the liquid crystal layer 11. Between the TFT substrate 9 and the color filter substrate 10, spherical spacers 12 for maintaining a constant distance between the substrates are disposed. Further, the display mode is not limited to the above VA mode, but a Twisted Nematic (TN) mode, a Super Twisted Nematic (STN) mode, an In-Plane Switching (IPS) mode, or the like can be used.

In the TFT substrate 9, a plurality of pixels (not shown) each of which is a minimum unit region of display are disposed in a matrix shape. In the TFT substrate 9, a plurality of source bus lines (not shown) are formed so as to extend parallel to each other, and a plurality of gate bus lines (not shown) are formed to extend parallel to each other and to be orthogonal to a plurality of source bus lines. Therefore, a plurality of source bus lines and a plurality of gate bus lines are formed in a lattice shape on the TFT substrate 9, and a rectangular region partitioned by the adjacent source bus lines and the adjacent gate bus lines forms a single pixel. The source bus lines are connected to the source electrode of TFTs described later, and the gate bus lines are connected to the gate electrodes of the TFTs.

TFTs 19, each of which includes a semiconductor layer 15, a gate electrode 16, a source electrode 17, a drain electrode 18, and the like, are formed on the surface on the liquid crystal layer 11 side of the transparent substrate 14 constituting the TFT substrate 9.

For example, a glass substrate can be used as the transparent substrate 14. A semiconductor layer 15 made of semiconductor materials such as, for example, a Continuous Grain Silicon (CGS), a Low-temperature Poly-Silicon (LPS), and an Amorphous Silicon (α-Si) is formed on the transparent substrate 14.

Further, a gate insulating film 20 is formed on the transparent substrate 14 so as to cover the semiconductor layer 15. As the material of the gate insulating film 20, for example, a silicon oxide film, a silicon nitride film, a laminated film thereof, or the like can be used.

The gate electrode 16 is formed on the gate insulating film 20 so as to oppose the semiconductor layer 15. As the material of the gate electrode 16, for example, a laminated film of tungsten (W)/nitride tantalum (TaN), molybdenum (Mo), titanium (Ti), aluminum (Al) or the like is used.

A first interlayer insulating film 21 is formed on the gate insulating film 20 so as to cover the gate electrode 16. As the material of the first interlayer insulating film 21, for example, a silicon oxide film, a silicon nitride film, a laminated film thereof, or the like can be used. The source electrode 17 and the drain electrode 18 are formed on the first interlayer insulating film 21. The source electrode 17 is connected to the source region of the semiconductor layer 15 through a contact hole 23 that penetrates the first interlayer insulating film 21 and the gate insulating film 20.

Similarly, the drain electrode 18 is connected to the drain region of the semiconductor layer 15 through a contact hole 22 that penetrates the first interlayer insulating film 21 and the gate insulating film 20. As the materials of the source electrode 17 and the drain electrode 18, conductive materials similar to that of the gate electrode 16 described above can be used. A second interlayer insulating film 24 is formed on the first interlayer insulating film 21 so as to cover the source electrode 17 and the drain electrode 18. As the material of the second interlayer insulating film 24, materials similar to that of the first interlayer insulating film 21 described above, or an organic insulating material can be used.

Pixel electrodes 25 are formed on the second interlayer insulating film 24. Each of the pixel electrodes 25 is connected to the drain electrode 18 through a contact hole 26 that penetrates the second interlayer insulating film 24. Accordingly, the pixel electrode 25 is connected to the drain region of the semiconductor layer 15 by using the drain electrode 18 as a relay electrode. As the material of the pixel electrode 25, transparent conductive materials such as Indium Tin Oxide (ITO), Indium Zinc Oxide (IZO), and the like can be used.

By this configuration, scanning signals are supplied through the gate bus lines, and when the TFT 19 is turned on, image signals supplied to the source electrode 17 through the source bus lines are supplied to the pixel electrode 25 through the semiconductor layer 15 and the drain electrode 18. Further, an alignment film 27 is formed on the entire surface of the second interlayer insulating film 24 so as to cover the pixel electrode 25. The alignment film 27 has an anchoring force which vertically aligns liquid crystal molecules constituting the liquid crystal layer 11. Further, the form of the TFT may be a bottom gate type TFT shown in FIG. 3, or may be a top gate type TFT.

On the other hand, a black matrix 30, a color filter 31, a planarization layer 32, an opposing electrode 33, and an alignment film 34 are sequentially formed on the surface of the liquid crystal layer 11 side of the transparent substrate 29 constituting the color filter substrate 10. The black matrix 30 has a function to shield the transmission of light in a region between pixels. The black matrix 30 is made of a metal such as chromium (Cr) or a multilayer film of Cr/Cr oxide, or a photo resist in which carbon particles are dispersed in a photosensitive resin.

The dyes of the respective colors of Red (R), Green (G), and Blue (B) are included in the color filter 31. A color filter 31 of any one of R, G, and B is disposed so as to oppose one of the pixel electrodes 25 on the TFT substrate 9. The planarization layer 32 is made of an insulating film to cover the black matrix 30 and the color filter 31. The planarization layer 32 has a function of flattening in order to alleviate the steps that are made by the black matrix 30 and the color filter 31.

An opposing electrode 33 is formed on the planarization layer 32. As the material of the opposing electrode 33, a transparent conductive material similar to the pixel electrode 25 is used. In addition, an alignment film 34 having a vertical anchoring force is formed on the entire surface of the opposing electrode 33. Further, the color filter 31 may have a multicolor configuration of three colors R, G, and B or more.

As shown in FIG. 2, the backlight 2 includes a light source 36 such as a light emitting diode and a cold-cathode tube, and a light guide plate 37 emitting the light toward the liquid crystal panel 4 by using internal reflection of the light emitted from the light source 36. The backlight 2 may be an edge light type in which a light source is disposed in the edge surface of a light guiding body, and a direct type in which a light source is disposed immediately below the light guide body.

As the backlight 2 used in the present embodiment, it is desirable to use a backlight having directivity by controlling the emission direction of light, so-called a directional backlight. It is possible to reduce a blur and to improve the use efficiency of light by using the directional backlight which causes the collimated or substantially collimated light to enter the light diffusion section of the viewing angle widening film 7 described later. The directional backlight described above can be realized by optimizing the shape and arrangement of the reflection pattern formed in the light guide plate 37. Alternatively, the directivity may be realized by mounting a louver on the backlight. In addition, a first polarizing plate 3 functioning as a polarizer is provided between the backlight 2 and the liquid crystal panel 4. In addition, the second polarizing plate 5 functioning as a polarizer is provided between the liquid crystal panel 4 and the viewing angle widening film 7.

Hereinafter, the viewing angle widening film (light diffusion member) which is an embodiment will be described in detail.

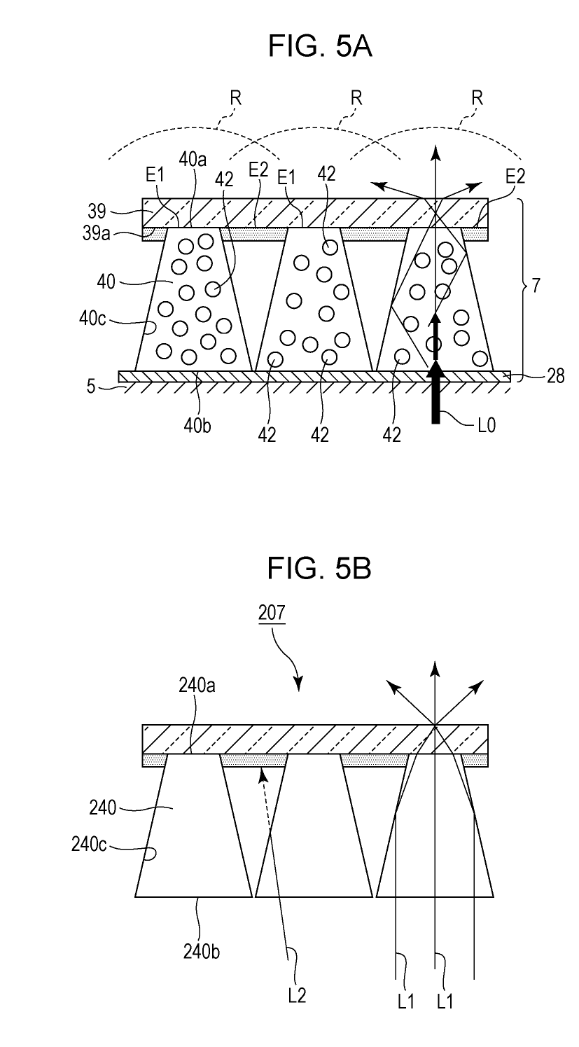

FIG. 5A is a cross-sectional view of the viewing angle widening film 7.

As shown in FIGS. 1, 2 and 5A, the viewing angle widening film 7 includes a substrate 39, a plurality of light diffusion sections 40, a light shielding layer 41, and a bonding layer 28. The plurality of light diffusion sections 40 are formed in first regions E1 of the one surface 39a (the surface on the side opposite to the viewing side) of the substrate 39. The light shielding layer 41 is formed in second regions E2 of the one surface 39a of the substrate 39. The bonding layer 28 is disposed so as to overlap a light incident end surface 40b on the opposing side to a light emitting end surface 40a in which the light diffusion section 40 is in contact with the one surface 39a of the substrate 39. As shown in FIG. 2, the viewing angle widening film 7 is bonded with the second polarizing plate 5 through the bonding layer 28 in an attitude in which the light incident end surface 40b of the light diffusion section 40 faces the second polarizing plate 5 and the substrate 39 side faces the viewing side.

As materials of the bonding layer, it is possible to use suitable adhesive materials depending on an adhesion target, such as adhesives of a pair of rubber-based and acrylic-based, a pair of silicone-based and vinyl-alkyl-ether-based, a pair of polyvinyl-alcohol-based and polyvinyl-pyrrolidone-based, a pair of polyacrylamide-based and cellulose-based, and the like. In particular, adhesive materials excellent in transparency, weather resistance, or the like are preferably used. Note that it is preferable to protect the bonding layer by being temporarily attached with a separator or the like until it is practically used.

In the following description, the horizontal direction of the screen of the liquid crystal panel 4 is defined as an x-axis, the vertical direction of the screen of the liquid crystal panel 4 is defined as a y-axis, and the thickness direction of the liquid crystal display device 1 is defined as a z-axis.

The light diffusion sections 40 of the present embodiment are formed so as to extend in the vertical direction (y-axis direction) of the screen of the liquid crystal panel 4. The light diffusion sections 40 are formed such that the horizontal cross-section (xy cross section) is an elongated rectangular shape, the area (surface area) of the light emitting end surface 40a side of the substrate 39 is small, and the area of the light incident end surface 40b side of the substrate 39 is large. The plurality of light diffusion sections 40 are disposed in a stripe shape at a regular interval with one another when viewed in the normal direction (z-axis direction) of the substrate 39. The light shielding layer 41 is disposed in a stripe shape between the adjacent light diffusion sections 40 that are disposed in a stripe shape as viewed in the normal direction (z-axis direction) of the substrate 39.

Typically, resins such as thermoplastic polymers or thermosetting resins, and photopolymerizable resins are used as the substrate 39. It is possible to use a substrate made of suitable transparent resins consisting of acrylic-based polymers, olefin-based polymers, vinyl-based polymers, cellulose-based polymers, amide-based polymers, fluorine-based polymers, urethane-based polymers, silicone-based polymers, imide-based polymers, or the like. For example, substrates made of transparent resins of, for example, tri-acetyl cellulose (TAC) films, polyethylene terephthalate (PET) films, cyclo olefin polymer (COP) films, polycarbonate (PC) films, polyethylene naphthalate (PEN) films, polyether sulfone (PES) films, polyimide (PI) films or the like are preferably used. In the manufacturing process described below, the substrate 39 is intended as a base when the material of the light shielding layer 41 and the light diffusion section 40 are applied later, and it is necessary to provide heat resistance and mechanical strength in the heat treatment process of the manufacturing process. Therefore, substrates made of, a glass, or the like, in addition to the substrate made of a resin may be used as the substrate 39.

However, it is preferable that the thickness of the substrate 39 be thin to the extent that does not impair the mechanical strength and the heat resistance. The reason is because the thicker the thickness of the substrate 39 is, the higher the possibility that blur may occur in the display. Further, the total light transmittance of the substrate 39 is preferably 90% or more on the provision of JIS K7361-1. If the total light transmittance is 90% or more, the sufficient transparency is achieved. In the present embodiment, for example, a TAC film of a thickness of 100 μm is used.

The light diffusion section 40 is formed of organic materials having optical transparency and photosensitivity such as acrylic resins, epoxy resins or the like. Further, the total light transmittance of the light diffusion section 40 is preferably 90% or more on the provision of JIS K7361-1. If the total light transmittance is 90% or more, the sufficient transparency is achieved. The light diffusion section 40 may be formed of acrylic resin-based transparent negative resists or epoxy resin-based transparent negative resists.

As materials of the light diffusion section 40, for example, it is possible to use a mixture made of a transparent resin obtained by mixing polymerization initiators, coupling agents, monomers, organic solvents, or the like with resins such as the acrylic-based resins, the epoxy-based resins, and the silicone-based resins. Further, the polymerization initiators may include various additional components such as stabilizers, inhibitors, plasticizers, optical brighteners, mold release agents, chain transfer agents, and other photopolymerizable monomers. Other materials described in Japanese Patent No. 4129991 can be used.

As shown in FIG. 5A, when viewed as a whole, in the light diffusion section 40, the area of the light emitting end surface 40a is small, and the cross-sectional area in the horizontal direction is gradually increased (is increased) as being away from the substrate 39. The light diffusion section 40 when viewed from the substrate 39 has the shape of a truncated pyramid shape of a so-called inverse tapered shape. The light incident end surface 40b and the light emitting end surface 40a of the light diffusion section 40 are formed parallel to each other. The width W1 (dimensions of the lateral direction) of the light incident end surface 40b of the light diffusion section 40 is, for example, 20 μm, and the pitch P1 between the adjacent light diffusion section 40s is also 20 μm.

In addition, the side surface 40c of the light diffusion section 40 may be a plane which, for example, spreads uniformly at a predetermined angle with respect to the light incident end surface 40b.

A plurality of light scattering bodies 42 which cause the light incident from the light incident end surface 40b to be weakly scattered (forward scattering) are dispersively disposed in the light diffusion section 40. The light scattering bodies 42 are particles (small pieces) formed of configuration materials having different refractive index from the materials configuring the light diffusion section 40. The light scattering bodies 42 may be randomly mixed and dispersed in the inside of the light diffusion section 40. For example, as materials of light scattering body 42, it is possible to use suitable transparent materials consisting of glasses or resins of acrylic-based polymers, olefin-based polymers, vinyl-based polymers, cellulose-based polymers, amide-based polymers, fluorine-based polymers, urethane-based polymers, silicone-based polymers, and imide-based polymers. Alternatively, the light scattering body 42 may be gas bubbles diffused into the light diffusion section 40. Further, it is possible to use scattering bodies or reflecting bodies without light absorption other than the transparent materials. For example, the shape of each light scattering body 42 can be formed in various shapes such as, spherical shapes, elliptical spherical shapes, flat shapes, polygonal cubes.

The light scattering body 42 may be formed such that the size thereof is, for example, about 0.5 μm to 20 μm and the size itself is uniform or random.

The light diffusion section 40 is a portion contributing to the transmission of light in the viewing angle widening film 7. In other words, while the light incident on the light diffusion section 40 from the light incident end surface 40b is totally reflected on the side surface 40c of a tapered shape in the light diffusion section 40 as shown in FIG. 5A, the light is forwardly scattered in the inside of the light diffusion section 40 by the plurality of light scattering bodies 42 which are dispersed in the inside of the light diffusion section 40, guided in a state of being confined substantially in the inside of the light diffusion section 40, and emitted from the light emitting end surface 40a.

As shown in FIGS. 1, 2 and 5A, the light shielding layer 41 is formed in a second region E2 other than first regions E1 which are formation regions of a plurality of light diffusion sections 40, among the surfaces on which the light diffusion sections 40 of the substrate 39 are formed. That is, the light shielding layer 41 is formed in a region different from the first regions E1. As an example, the light shielding layer 41 is made of organic materials having light absorbing property and photosensitivity such as a black resist. As the light shielding layer 41, other than the above materials, metallic films such as multilayer films of chromium (Cr) or Cr/Cr oxides, things made into black inks by mixing pigments and dyes used in black inks, multicolor inks may be used. Other than the above mentioned materials, it does not matter as long as materials have light blocking property. The width (dimension in the lateral direction) of the light shielding layer 41 is, for example, about 10 μm.

The layer thickness of the light shielding layer 41 may be set smaller than the height from the light incident end surface 40b to the light emitting end surface 40a of the light diffusion section 40. In a case of the present embodiment, the layer thickness of the light shielding layer 41 is about 150 nm, for example. On the other hand, the height (dimension) from the light incident end surface 40b to the light emitting end surface 40a of the light diffusion section 40 is about 50 μm as an example. Therefore, in the gaps among a plurality of light diffusion sections 40, the light shielding layer 41 is present in portions thereof being in contact with the one surface of the substrate 39 and air is present in the other portions thereof.

As shown in FIG. 5B, in the viewing angle widening film (light diffusion member) 207 in the related art, when the inclination angle of the side surface 240c of the light diffusion section 240 is constant, the light L1 which is incident perpendicular to the light incident end surface 240b of the light diffusion section 240 is totally reflected on the side surface 240c of the light diffusion section 240.

However, if the inclination angle of the side surface 240c of the light diffusion section 240 is constant, the light L1 which is incident perpendicular to the light incident end surface 240b of the light diffusion section 240 is emitted focusing on a specific diffusion angle. As a result, it is not possible to diffuse uniformly the light in a wide angle range, but the bright display can be obtained only in the specific viewing angle. In addition, if the light diffusion sections 240 are arranged regularly, the light emitted from the light emitting end surface 240a becomes regular, and thus there is a possibility that moire (interference fringe) occurs.

In contrast, as shown in FIG. 5A, in the viewing angle widening film 7 of the present embodiment, a plurality of light scattering bodies 42 which weakly scatter (forward scattering) the light incident from the light incident end surface 40b are disposed and dispersed. Thus, after even the light L0 incident from any position such as a center portion or an end portion of the light incident end surface 40b is incident to the light diffusion sections 40, the light L0 is repeatedly reflected by a large number of the light scattering bodies 42 (forward scattering). Then, light is emitted from the light emitting end surface 40a as a constant light (uniform light) in a wide angle range R without leaning by a certain emission angle. In this manner, since the viewing angle widening film 7 of the present embodiment can diffuse the light uniformly in the wide angle range R, thereby performing a uniformly bright display in the wide viewing angle.

In addition, if the amount of the light scattering bodies 42 included in the light diffusion sections 40 is too large, the number of times that light incident from the light incident end surface 40b is reflected by the light scattering bodies 42 is increased and the amount to be emitted from the light emitting end surface 40a is reduced. In other words, the loss of light is increased. The amount of the light scattering bodies 42 included in the light diffusion section 40 may be set to some amount capable of bending the traveling angle of the light incident from the light incident end surface 40b. In other words, by setting appropriately the amount of the light scattering bodies 42 included in the light diffusion section 40, it is possible to reduce the loss of light and to make the diffusion properties to be uniform.

Generally, it has been known that when patterns with regularity such as stripes and lattices are superimposed with each other, if the period of each pattern is slightly shifted, the interference fringe shape (moire) is viewed. For example, if a viewing angle widening film in which a plurality of light diffusion sections are arranged at a constant pitch and a liquid crystal panel in which a plurality of pixels are arranged at a constant pitch are superimposed, there is a possibility that moire is generated between the periodic pattern by the light diffusion section of the viewing angle widening film and the periodic pattern by the pixels of the liquid crystal panel. In contrast, according to the liquid crystal display device 1 of the present embodiment, even if the plurality of light diffusion sections 40 are arranged regularly, since the light incident from the light incident end surface 40b is emitted with being scattered forwardly by the light scattering body 42 within the light diffusion section 40, the emitted light is irregular, so it is possible to maintain the high display quality by effectively avoiding the generation of moire (interference fringe).

In the case of the present embodiment, since air is interposed between the adjacent light diffusion sections 40, assuming that the light diffusion section 40 is made of for example, an acrylic resin, the side surface 40c of the light diffusion section 40 becomes an interface between the acrylic resin and air. Here, even if the surroundings of the light diffusion section 40 is filled with other low refractive index materials, the refractive index difference at the interface between the outside and the inside of the light diffusion section 40 is maximum when air is present as compared to a case when any low refractive index materials exists outside. Therefore, by Snell's law, in the configuration of the present embodiment, a critical angle is the smallest, and an incident angle range in which light is totally reflected on the side surface 40c of the light diffusion section 40 is the widest. As a result, loss of light is further suppressed and thus it is possible to obtain a high brightness.

Further, if the light transmitted through the side surface 40c of the light diffusion section 40 without hitting the light scattering bodies 42 is increased, there is a possibility that the loss of the light amount occurs and the image of high brightness cannot be obtained, so in the liquid crystal display device 1, it is preferable to use a backlight which emits light at an angle at which light is not incident to the side surface 40c of the light diffusion section 40 at the critical angle or less, a so-called backlight having directivity.

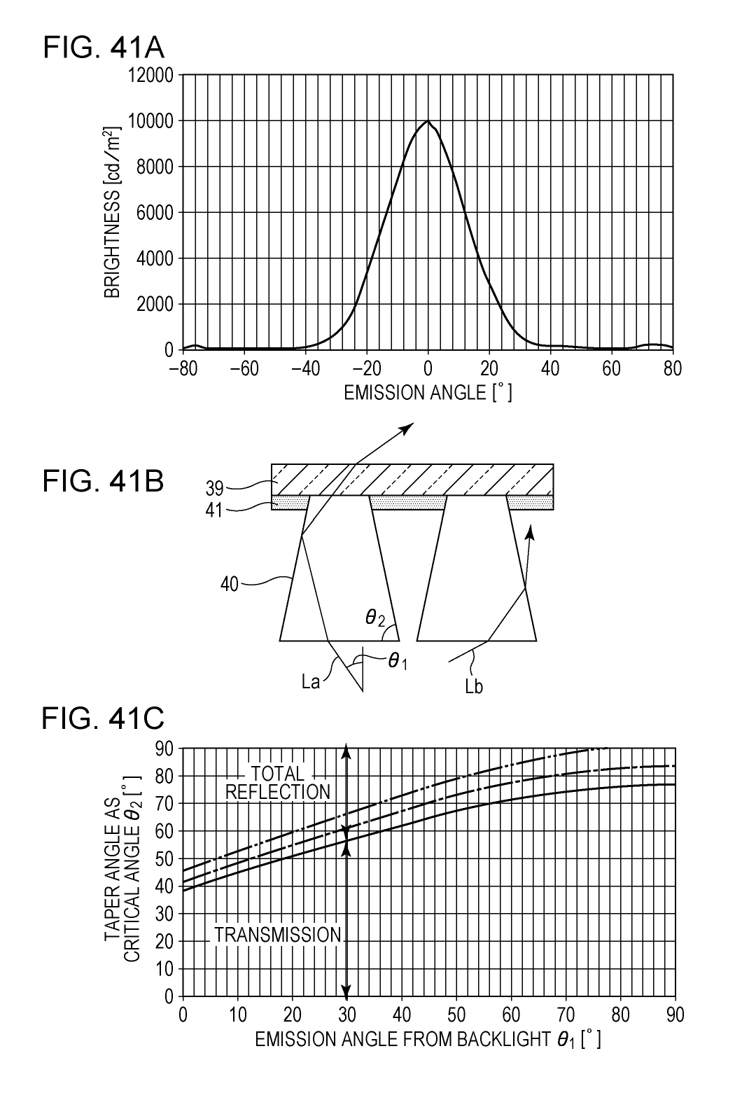

FIG. 41A is a graph showing brightness angle characteristics of the directional backlight. In this figure, the horizontal axis represents the emission angle (degree) and the vertical axis represents the brightness (cd/m²) with regard to the light emitted from the directional backlight. It is understood that in the directional backlight to which the light diffusion section 40 used here is applied, almost all emitted light is within the emission angle ±30 degree. The combination of the directional backlight and the viewing angle widening film realizes a configuration in which the blur is reduced and light use efficiency is high.

As shown in FIG. 41B, θ₁ is defined as an emission angle from the backlight, θ₂ is defined as a taper angle of the light diffusion section 40. The light L0 incident to the light diffusion section 40 is caused to be totally reflected at the tapered portion and emitted from the surface of the substrate 39 to the viewing side, but there is a case where the light L1 having a large incidence angle is transmitted without being totally reflected at the tapered portion and loss of incident light occurs.

FIG. 41C shows a relationship between an emission angle from the backlight and a taper angle. In FIG. 41C, the two-dot chain line indicates a case where the transparent resin refractive index n=1.4, the dashed line indicates a case where the transparent resin refractive index n=1.5, and the solid line indicates a case where the transparent resin refractive index n=1.6. For example, in a case where light transmission section of the transparent resin refractive index n=1.6 has a taper angle of less than 57 degree, the light of the backlight emission angle of ±30 degree is transmitted in a tapered shape without being totally reflected, so light loss occurs. In order to totally reflect the light within the light emission angle of ±30 degree in a tapered shape without loss, it is desirable that the taper angle of the light diffusion section 40 be 57 degree or more to less than 90 degree.

### Modification Example of the First Embodiment

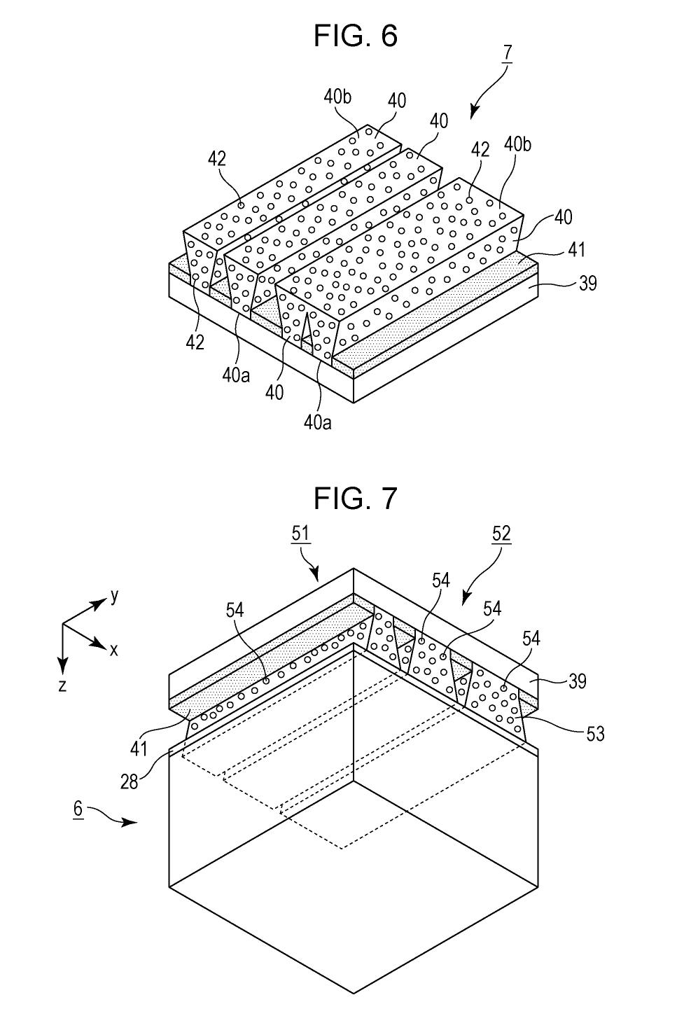

In addition, as shown in FIG. 6, a portion of the plurality of light diffusion sections 40 formed on one surface 39a of the substrate 39 may be formed so as to be connected to each other. In other words, in the example shown in FIG. 6, the light incident end surfaces 40b sides of the mutually adjacent light diffusion sections 40 are connected to each other. Incorporating irregularly such a configuration makes the emitted light to further randomly emit, so it is possible to effectively prevent the generation of moire (interference fringes).

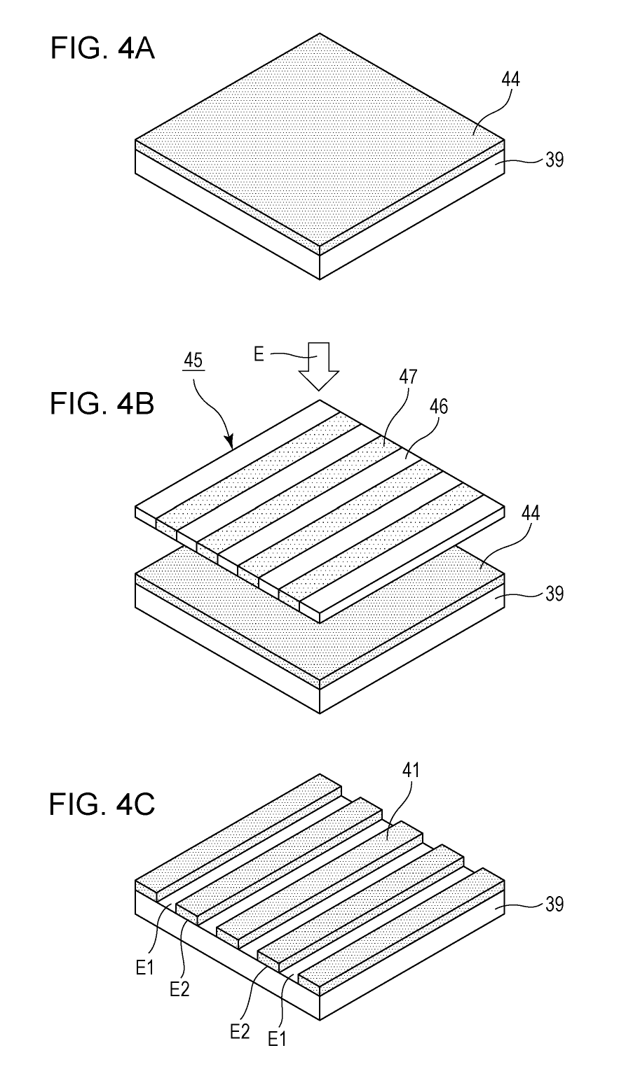

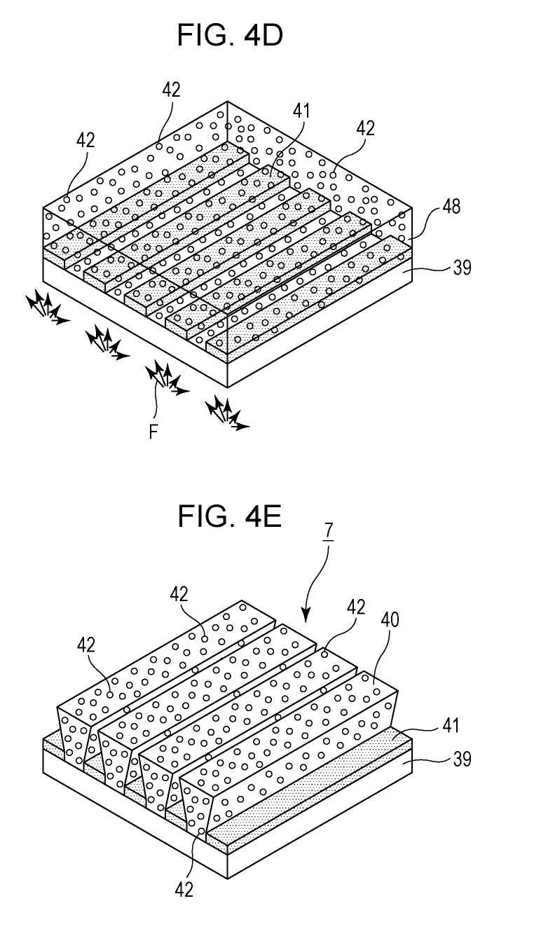

Next, a method for producing of a liquid crystal display device 1 having the above configuration will be described with reference to FIGS. 4A to 4E.

In the following, the description will be made focusing on the manufacturing process of the viewing angle widening film 7.

First, if the outline of the manufacturing process of the liquid crystal display body 6 is described, first, each of the TFT substrate 9 and the color filter substrate 10 is produced. Thereafter, a surface having TFT 19 of the TFT substrate 9 formed and a surface having the color filter 31 of the color filter substrate 10 formed are disposed so as to oppose each other, and the TFT substrate 9 and the color filter substrate 10 are bonded through a seal member.

Thereafter, a liquid crystal is injected in the space surrounded by the TFT substrate 9, the color filter substrate 10, and the seal member. Then, a first polarizing plate 3 and a second polarizing plate 4 are respectively bonded to the both sides of the liquid crystal panel 4 formed in this manner by an optical adhesive, or the like. Through the above process, the liquid crystal display body 6 is completed.

Further, since the method for producing of the TFT substrate 9 and the color filter substrate 10 have been known in this field from the past, the description thereof will be omitted.

First, as shown in FIG. 4A, a substrate 39 of tri-acetyl cellulose of a thickness of 100 μm in 10 cm square is prepared, and a black negative resist containing carbon as a light shielding layer material is applied on one surface of the substrate 39 by using the spin coating method to form a coating film 44 having a film thickness of 150 nm.

Next, the substrate 39 having the above coating film 44 formed is placed on a hot plate and the coating film is pre-baked at a temperature of 90° C. Thus, the solvent in the black negative resist is volatilized.

Next, using an exposure apparatus, as shown in FIG. 4B, exposure is performed by the coating film 44 being irradiated with the light E through the photo mask 45 having a plurality of light shielding patterns 47 provided. At this time, an exposure apparatus using a mixed ray of an i ray of a wavelength of 365 nm, an h ray of a wavelength of 404 nm, and a g ray of a wavelength of 436 nm is used. The exposure amount is 100 mJ/cm². In the case of the present embodiment, since the exposure of a transparent negative resist is performed by using the light shielding layer 41 as a mask in the next process so as to form the light diffusion section 40, the position of the shielding portion 47 of the photo mask 45 corresponds to the formation position of the light diffusion section 40, that is, a first region. The plurality of light shielding patterns 47 all have strip-shaped patterns of a width of 10 μm and are disposed at 20 μm pitch.

It is desirable that the pitch of the light shielding pattern 47 be smaller than the distance (pitch) of the pixels of the liquid crystal panel 4. Thus, at least one light diffusion section 40 is formed in the pixel, so it is possible to achieve a wide viewing angle when combined with, for example, a liquid crystal panel having a small pixel pitch used in a mobile device, or the like.

After exposure is performed using the above photo mask 45, a coating film 44 made of a black negative resist is developed using a designated developing solution and dried at 100° C., and thus as shown in FIG. 4C, a plurality of light shielding layers 41 are formed in the second regions on one surface of the substrate 39. The opening portions between the adjacent light shielding layers 41 correspond to the formation region of the light diffusion section 40 in the next process. Further, although the light shielding layer 41 is formed by a photolithography method using the black negative resist in the present embodiment, instead of this configuration, if a photo mask is used in which the light shielding pattern 47 and the opening portion 46 of the present embodiment are reversed, it is possible to use a positive resist. Alternatively, a light shielding layer 41 subjected to patterning using a vapor deposition method, a printing method, or the like may be directly formed.

Next, as shown in FIG. 4D, a transparent negative resist in which a large number of light scattering bodies 42 such as glass beads are dispersed in an acrylic resin as a configuration material of a light diffusion section 40 is applied on the upper surface of the light shielding layer 41 by using a spin coating method to form a coating film 48 (negative type photosensitive resin layer) of a film thickness of about 50 μm.

Next, the substrate 39 having the above coating film 48 formed is placed on a hot plate and the coating film 48 is pre-baked at a temperature of 95° C. Thus, the solvent in the transparent negative resist is volatilized.

Next, exposure is performed by the coating film 48 being irradiated with the diffusion light F by using the light shielding layer 41 as a mask from the substrate 39 side. At this time, an exposure apparatus using a mixed ray of an i ray of a wavelength of 365 nm, an h ray of a wavelength of 404 nm, and a g ray of a wavelength of 436 nm is used. The exposure amount is 500 mJ/cm². In the exposure process, parallel light or diffusion light is used.

Further, as means for irradiating the substrate 39 with the parallel light emitted from the exposure apparatus as the diffusion light F, a diffusing plate of about 50 haze is disposed on the light path of the light emitted from the exposure apparatus. By performing the exposure using the diffusion light F, the coating film 48 is exposed radially from the opening portion between the light shielding layers 41 to form a side surface of an inverse tapered shape of the light diffusion section 40.

Thereafter, the substrate 39 on which the exposure process is completed is placed on a hot plate and the post-exposure bake (PEB) of the coating film 48 is performed at a temperature of 95° C.

Next, the coating film 48 made of a transparent negative resist is developed using a designated developing solution and post-baked at 100° C. to form a plurality of light diffusion sections 40, in which the light scattering bodies 42 are dispersed, on one surface of the substrate 39 as shown in FIG. 4E.

Through the above process, the viewing angle widening film (light diffusion body) 7 of the present embodiment is completed. The total light transmittance of the viewing angle widening film 7 is preferably 90% or more. If the total light transmittance is 90% or more, the sufficient optical performance required for the viewing angle widening film can be exhibited. The total light transmittance is due to the provision of JIS K7361-1.

Further, although a liquid resist is applied in forming the light shielding layer 41 and the light diffusion layer 40 in the above example, instead of this configuration, a film-like resist may be affixed to one surface of the substrate 39.

Finally, as shown in FIG. 2, the viewing angle widening film 7 that has been completed is affixed to the liquid crystal display body 6 by forming a bonding layer 28 in a state where the substrate 39 faces the viewing side and a light diffusion section 40 is opposed to the second polarizing plate 5.

Through the above process, the liquid crystal display device 1 of the present embodiment is completed.

According to the present embodiment, as shown in FIG. 5A, the light L0 incident to the viewing angle widening film 7 is emitted from the viewing angle widening film 7 in a state where the angular distribution of the light L0 has become wider than before being incident to the viewing angle widening film 7. Therefore, the observer can view a good quality of display even if the observer tilts the line of sight from the front direction (vertical direction) of the liquid crystal display body 6. Particularly in the present embodiment, since the light diffusion sections 40 are extended in a stripe shape in the normal direction of the screen, the angular distribution spreads in the horizontal direction (left-right direction) of the screen of the liquid crystal display body 6. Therefore, the observer can view a good quality of display in a wide range in the left-right direction of the screen.

Further, since a large number of light scattering bodies 42 are dispersively disposed in the light diffusion section 40, the light L0 incident to the viewing angle widening film 7 is repeatedly reflected by the light scattering bodies 42 (forward scattering). Then, light is emitted from the light emitting end surface 40a as a constant light (uniform light) in a wide angle range R without leaning by a certain emission angle.

Therefore, even if the light diffusion sections 140 are regularly arranged, the light incident from the light incident end surface 40b is emitted while being forwardly scattered in the light diffusion sections 40 by the light scattering bodies 42, so the emitted right is irregular and the generation of moire (interference fringe) is effectively protected, thereby allowing the good display quality to be maintained.

Further, in the process of forming the light diffusion section 40, if it is assumed that the exposure is performed using the photo mask from the coating film 48 side made of a transparent negative resist, it is difficult to align the substrate 39 having the light shielding layer 41 of a minute size formed and the photo mask, and it is inevitable that deviation occurs. In contrast, since light is irradiated from the rear surface side of the substrate 39 by using the light shielding layer 41 as a mask in the case of the present embodiment, the light diffusion sections 40 are formed in a state of being self-aligned to the positions of the opening portions of the light shielding layer 41. As a result, the light diffusion section 40 and the light shielding layer 41 becomes a state of being in close contact and there is no gap therebetween, it is possible to prevent a decrease in contrast ratio due to light leakage.

### Second Embodiment

Hereinafter, a second embodiment of the present invention will be described using FIGS. 7 to 9E.

The basic configuration of a liquid crystal display device of the present embodiment is the same as in the first embodiment, and the shape of a light diffusion section of a viewing angle widening film is different from that of the first embodiment. Therefore, in the present embodiment, the description of the basic configuration of the liquid crystal display device is omitted, and only the viewing angle widening film will be described.

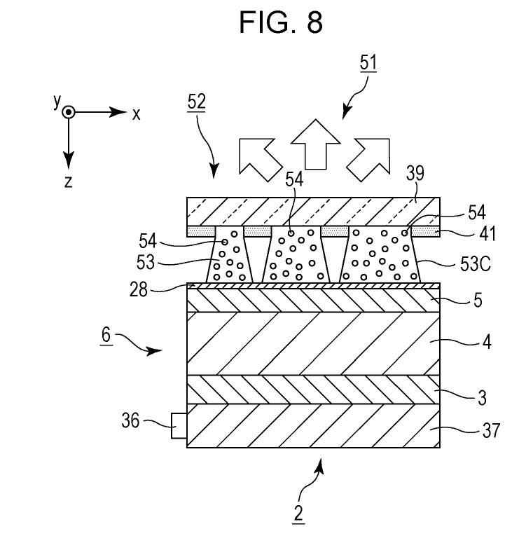

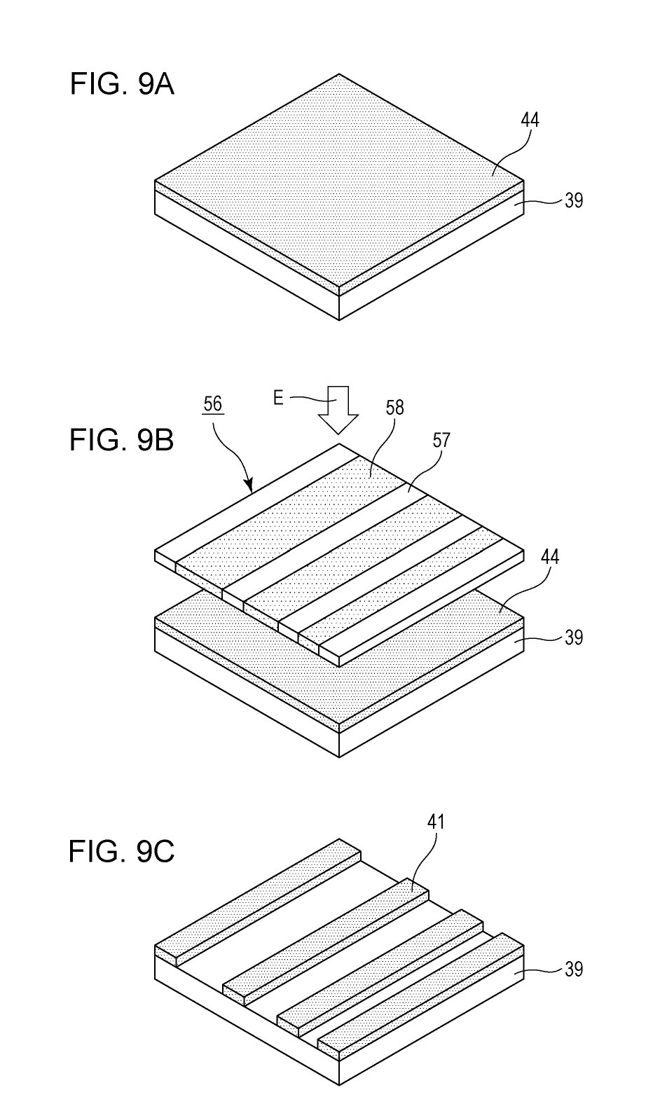

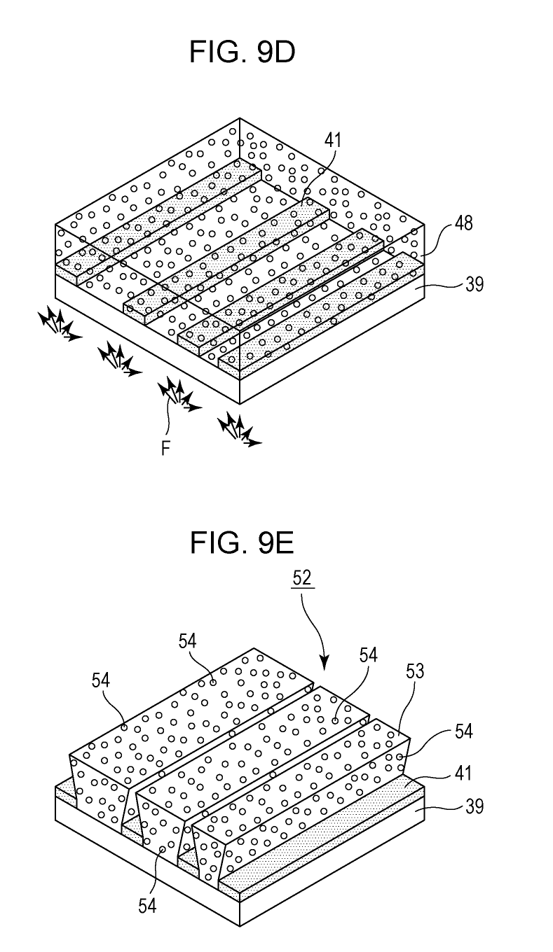

FIG. 7 is a vertical cross-sectional view showing a liquid crystal display device of the present embodiment. FIG. 8 is a vertical cross-sectional view showing the viewing angle widening film of the present embodiment. FIGS. 9A to 9E are perspective views showing a manufacturing process of the viewing angle widening film according to the sequence.

In FIGS. 7, 8, and 9A to 9E, the same reference numerals are given to the common components with those in the drawings used in the first embodiment, and thus detailed description thereof will be omitted.

In the first embodiment, the widths (dimensions in the lateral direction) of the plurality of light diffusion sections 40 are constant. In contrast, in the viewing angle widening film 52 of the present embodiment, as shown in FIGS. 7 and 8, the width of (dimension in the lateral direction) of the light shielding layer 41 is constant, and the widths (dimension in the lateral direction) of the plurality of light diffusion sections 53 in which the light scattering bodies 52 are dispersed are different randomly. In other words, the widths of the plurality of light diffusion sections 53 are not constant, and the average width obtained by averaging the widths of the plurality of light diffusion sections 53 is, for example, 10 μm. Further, the inclination angles of the side surface 53c of the light diffusion sections 53 are uniform over the plurality of light diffusion sections 53 and the same as in the first embodiment. Other configurations are the same as in the first embodiment.

In the manufacturing process of the viewing angle widening film 52 of the present embodiment, as shown in FIG. 9B, the photo mask 56 used in forming the light shielding layer 41 has opening portions 57 of the same width and light shielding patterns 58 of which the widths are randomly different. In designing the photo mask 56, the following method is used. First, the opening portions 57 of the same width are arranged at a constant pitch. Next, the reference position data of each opening portion 57 such as, for example, the center points of the opening portions 57 is made to fluctuated and the position of the opening portion 57 is made to vary using a random function. Thus, it is possible to achieve a plurality of light shielding patterns 58 in which the widths of the opening portions are randomly different. The manufacturing process itself of the viewing angle widening film 52 is the same as in the first embodiment.

Even in the liquid crystal display device 51 of the present embodiment, it is possible to achieve the same effects as that of the first embodiment in which the viewing angle widening film capable of exhibiting a desired light diffusion property, particularly in the horizontal direction (left-right direction) of a screen can be manufactured without complicating manufacturing processes.

Further, according to the liquid crystal display device 51 of the present embodiment, even if the light diffusion sections 50 are regularly arranged, the light incident from the light incident end surface 50b is emitted while being forwardly scattered in the light diffusion sections 50 by the light scattering bodies 52. Therefore, the emitted right is irregular and the generation of moire (interference fringe) is effectively protected, thereby allowing the good display quality to be maintained. Furthermore, since the width of the plurality of light diffusion sections 53 are random, it is possible to more reliably protect the generation of moire caused by interference between the regular arrangements of the pixels of the liquid crystal panel 4 and to maintain the display quality.

### Modification Example of the Second Embodiment

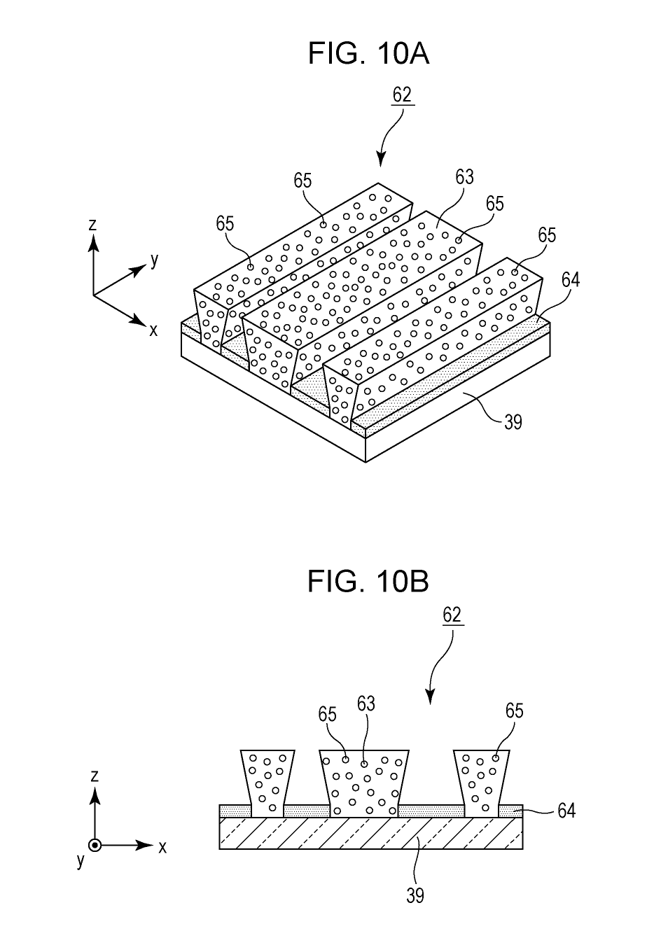

FIG. 10A is a perspective view showing a modification example of the viewing angle widening film of the above embodiments.

FIG. 10B is a cross-sectional view showing the modification example of the viewing angle widening film.

Although the width of the light shielding layer 41 is assumed to be constant in the above embodiments, as the viewing angle widening film 62 shown in FIGS. 10A and 10B, the width of the light shielding layer 64 may be random as well as that the width of the light diffusion section 63 is random.

Even in the configuration, by the width of the light shielding layer 64 being set randomly in addition to the forward scattering operation of the light scattering bodies 65 dispersed in the light diffusion sections 63 and the width of the light diffusion section 63 being set randomly, an effect is achieved in which the generation of moire is more reliably suppressed and the display quality can be maintained.

However, in a case where the inclination angles of the side surfaces of the plurality of light diffusion sections 63 are constant and the width of the light shielding layer 41 are random, there is a possibility that the proportion of the light absorbed in the light shielding layer 64 to the light incident on the viewing angle widening film 62 is increased, and the use efficiency of light is slightly reduced. From this view point, it is preferable that the width of the light shielding layer be constant.

### Third Embodiment

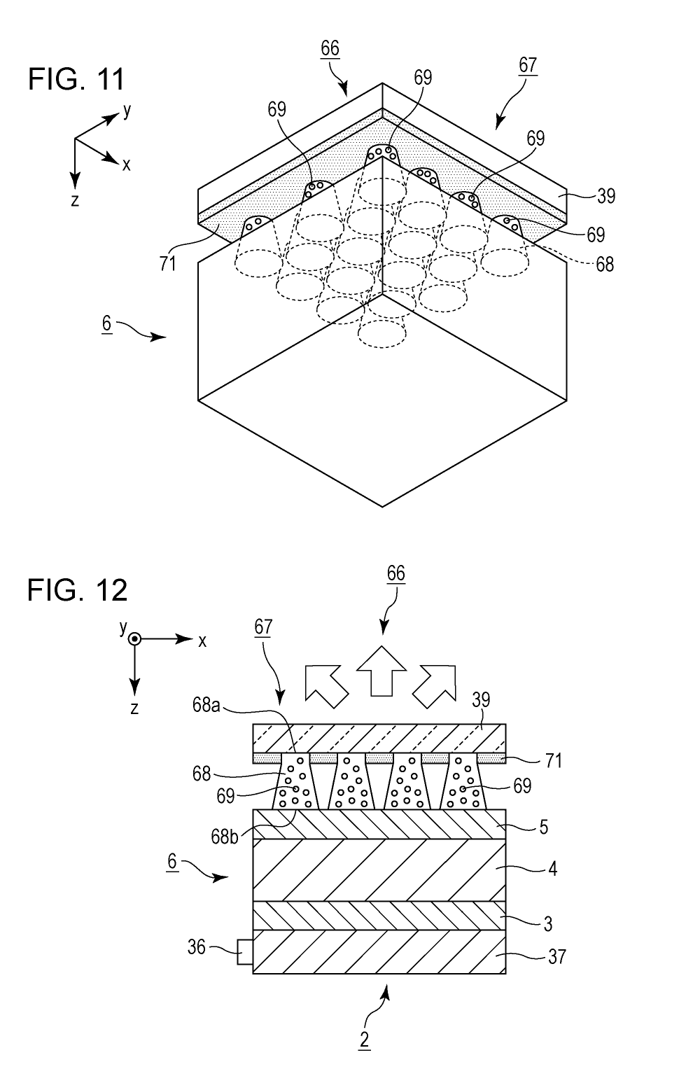

Hereinafter, a third embodiment of the present invention will be described using FIGS. 11 to 14B.

The basic configuration of a liquid crystal display device of the present embodiment is the same as in the first and second embodiments, and the shape of a light diffusion section of a viewing angle widening film is different from that of the first and second embodiments. Therefore, in the present embodiment, the description of the basic configuration of the liquid crystal display device is omitted, and only the viewing angle widening film will be described.

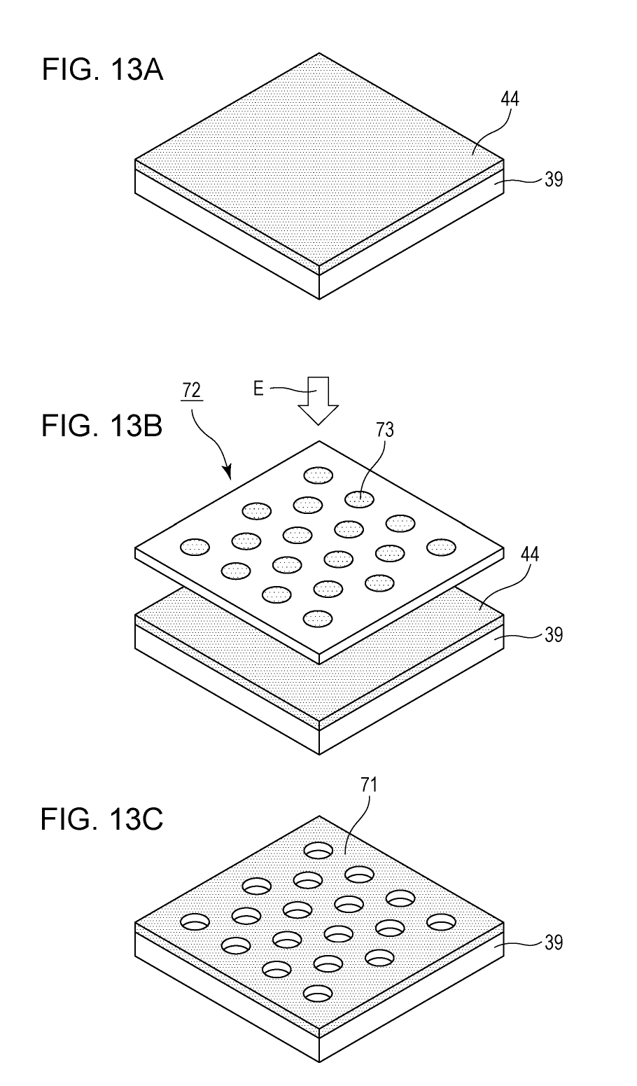

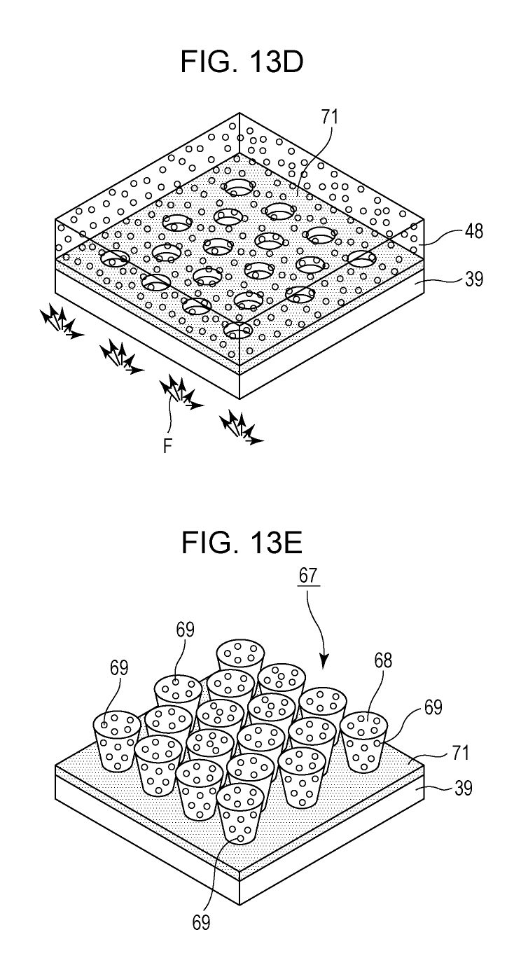

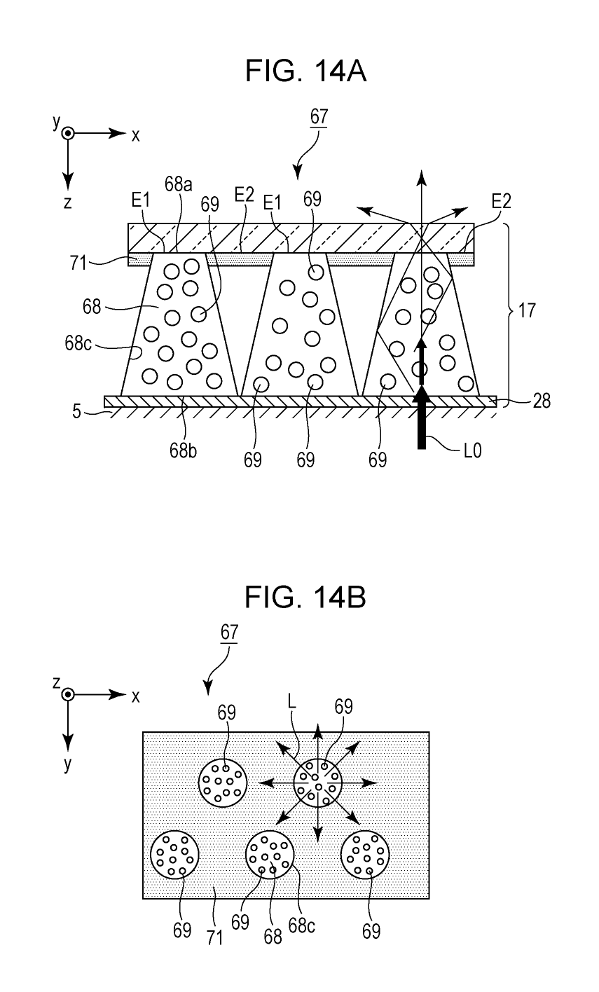

FIG. 11 is a perspective view of the liquid crystal display device of the present embodiment. FIG. 12 is a cross-sectional view of the liquid crystal display device. FIGS. 13A to 13E are perspective views showing a manufacturing process of the viewing angle widening film of the present embodiment according to the sequence. FIGS. 14A and 14B are diagrams for explaining the operation of the viewing angle widening film.

In FIGS. 11, 12, 13A to 13E, 14A, and 14B, the same reference numerals are given to the common components with those in the drawings used in the first and second embodiments, and thus detailed description thereof will be omitted.

In the first and second embodiments, the plurality of light diffusion sections are formed in a band shape so as to extend in the y-axis direction. In contrast, as shown in FIGS. 11 and 12, in the viewing angle widening film 67 of the present embodiment, the horizontal cross-section of the light diffusion section 68 in which a large number of light scattering bodies 69 are scattered therein when the light diffusion section 68 is cut in a surface (xy plane) parallel to one surface of the substrate 39 is circular, the area of the horizontal cross-section of the substrate 39 side serving as the light emitting end surface 68a is small, and as being away from the substrate 39, the area of the horizontal cross-section is increased gradually. In other words, the shape of each light diffusion section 68 is a substantially truncated cone.

A plurality of light diffusion sections 68 are scatteringly disposed regularly on the substrate 39. Among the plurality of light diffusion sections 68, for example, the light diffusion sections 68 of each column aligned in the y-axis direction are disposed at a constant pitch, and the light diffusion sections 68 of each row aligned in the x-axis direction are disposed at a constant pitch. Further, the light diffusion sections 68 of predetermined columns aligned in the y-axis direction and the light diffusion sections 68 of columns adjacent to the columns in the x-axis direction are disposed at positions each shifted by ½ pitch in the y-axis direction. For example, the diameter of the light emitting end surface 68a of the light diffusion section 68 is 20 μm and the pitch between the adjacent light diffusion sections 68 is 25 μm.

Since the plurality of light diffusion sections 68 are scatteringly disposed regularly on the substrate 39, the light shielding layer 71 of the present embodiment is formed continuously on the substrate 39.

Then, each light diffusion section 68 is the same as in the first embodiment in that the light scattering bodies 69 are disposed and dispersed therein and the inclination angle of the side surface 68c of the light diffusion section 68 is preferably 60 degree or more to less than 90 degree. Other configurations of the light diffusion section 68 are the same as in the first embodiment.

In the manufacturing process of the viewing angle widening film 67 of the present embodiment, as shown in FIG. 13B, the photo mask 72 used in forming the light shielding layer 71 has a plurality of circular light shielding patterns 73. Manufacturing process itself of the viewing angle widening film 67 is the same as in the first embodiment.

Even in the liquid crystal display device 66 of the present embodiment, it is possible to achieve the same effects as those of the first and second embodiments in which the viewing angle widening film capable of exhibiting a desired light diffusion property can be manufactured without complicating manufacturing processes.

In a case of the present embodiment, as shown in FIG. 14A, the cross-sectional shape of the light diffusion section 68 in the xz plane is the same as the light diffusion section 40 of the first embodiment (see FIG. 5A). Accordingly, the operation of widening the angle distribution by the viewing angle widening film 67 in the xz plane is also the same as in the first embodiment. However, if viewing from the front direction (z-axis direction) of the screen of the liquid crystal display device 66, the shape of the light diffusion section 40 of the first embodiment is a line shape, while as shown in FIG. 14B, the shape of the light diffusion section 68 of the present embodiment is circular.

Therefore, the light L0 incident to the light diffusion section 68 is scattered forwardly by the light scattering bodies 69 which are dispersed in the inside thereof, and the light L as emitting light is diffused toward all orientations of 360 degrees. Therefore, according to the viewing angle widening film 67 of the present embodiment, the observer can view a good quality of display from all orientations of a screen, not only from the horizontal direction of the screen as in the first and second embodiments.

### Modification Example of the Third Embodiment

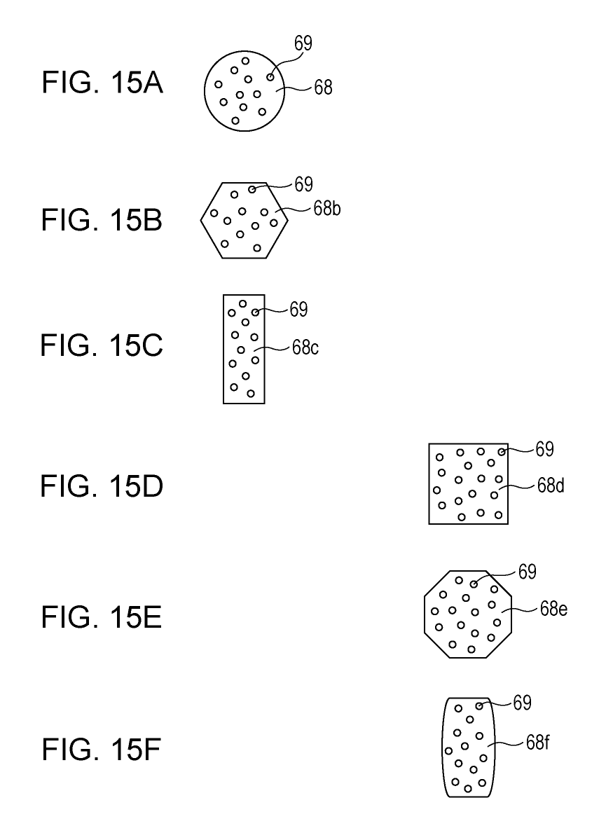

Further, although an example of the light diffusion section 68 of which the planar shape is circular is shown in FIG. 15A, in the above embodiments, for example, and in FIG. 15B, the light diffusion section 68b of a hexagonal planar shape in which the light scattering bodies 69 are dispersed may be used. Alternatively, as shown in FIG. 15C, the light diffusion section 68c of a rectangular planar shape in which the light scattering bodies 69 are dispersed may be used. Alternatively, as shown in FIG. 15D, the light diffusion section 68d of a square planar shape in which the light scattering bodies 69 are dispersed may be used. Alternatively, as shown in FIG. 15E, the light diffusion section 68e of an octagonal planar shape in which the light scattering bodies 69 are dispersed may be used. Alternatively, as shown in FIG. 15F, the light diffusion section 68f of the shape in which two opposing sides of a rectangle are curved outwards and in which the light scattering bodies 69 are dispersed may be used.

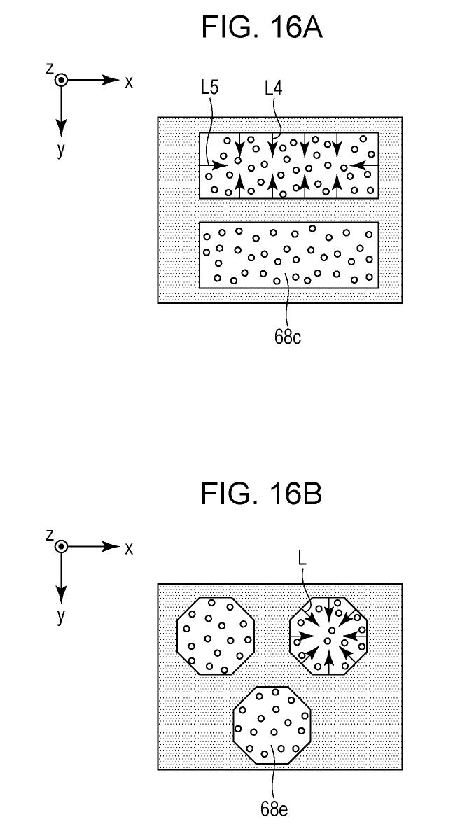

For example, in the light diffusion section 68c of a rectangular shape shown in FIG. 16A, the diffusion of light L4 in the direction perpendicular to the long side is stronger than the diffusion of light L5 in the direction perpendicular to the short side. Therefore, it is possible to realize a viewing angle widening film in which the strength of the diffusion of light varies depending on the length of the side in the vertical direction (up-down direction) and the horizontal direction (left-right direction). Further, in the light diffusion section 68e of the octagonal shape shown in FIG. 16B, light L can be diffused with concentration in the vertical direction, the horizontal direction, and the oblique 45-degree direction in which the viewing angle characteristics are particularly important in the liquid crystal display device. In this manner, in a case where the anisotropy of the viewing angle is required, different light diffusion characteristics can be obtained by appropriately changing the shape of the light diffusion section.

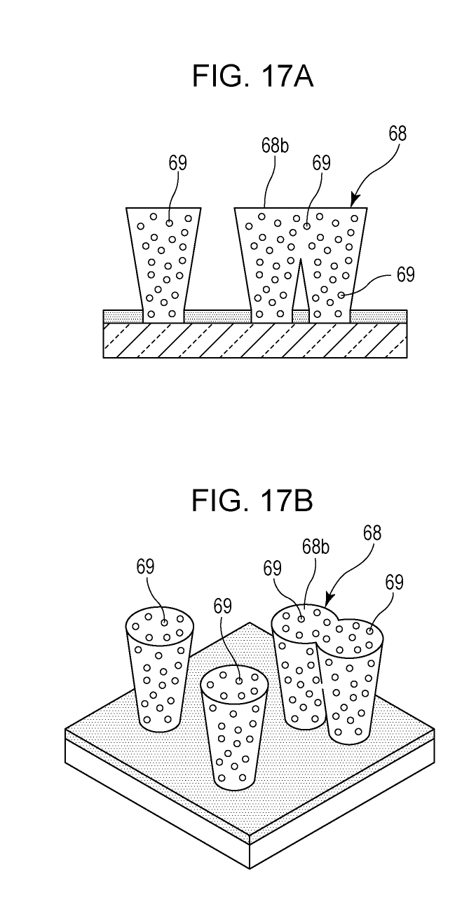

In addition, for example, as shown in FIGS. 17A and 17B, a portion of the plurality of light diffusion sections 68 formed on one surface 39a of the substrate 39 may be formed so as to be connected to each other. In other words, in the example shown in FIGS. 17A and 17B, the light incident end surfaces 68b sides of the mutually adjacent light diffusion sections 68 of a cone shape are connected to each other. Incorporating irregularly such a configuration makes the emitted light to further randomly emit, so it is possible to effectively prevent the generation of moire (interference fringes).

### Fourth Embodiment

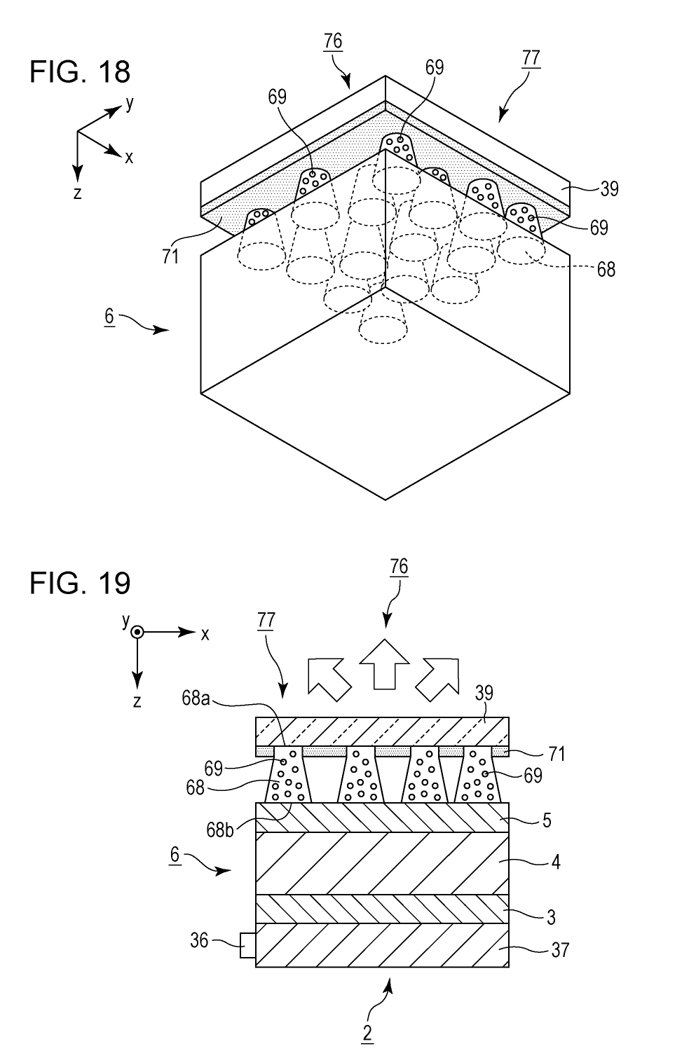

Hereinafter, a fourth embodiment of the present invention will be described using FIGS. 18 to 20E.

The basic configuration of a liquid crystal display device of the present embodiment is the same as in the third embodiment, except that the arrangement of a light diffusion section of a viewing angle widening film is different from that of the third embodiment. Therefore, in the present embodiment, the description of the basic configuration of the liquid crystal display device is omitted, and only the viewing angle widening film will be described.

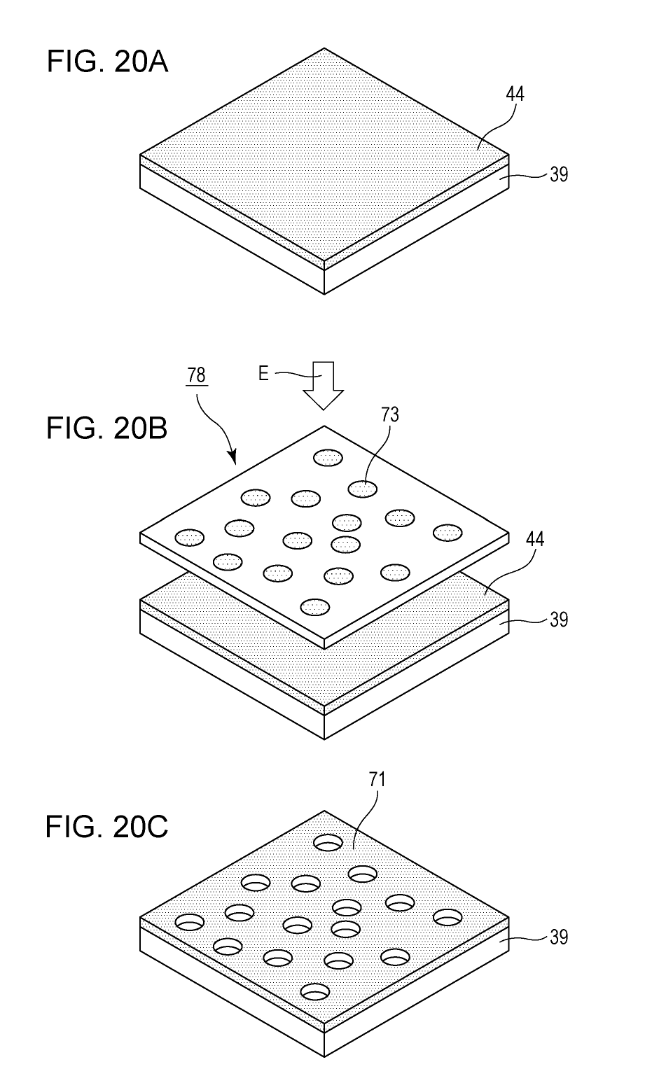

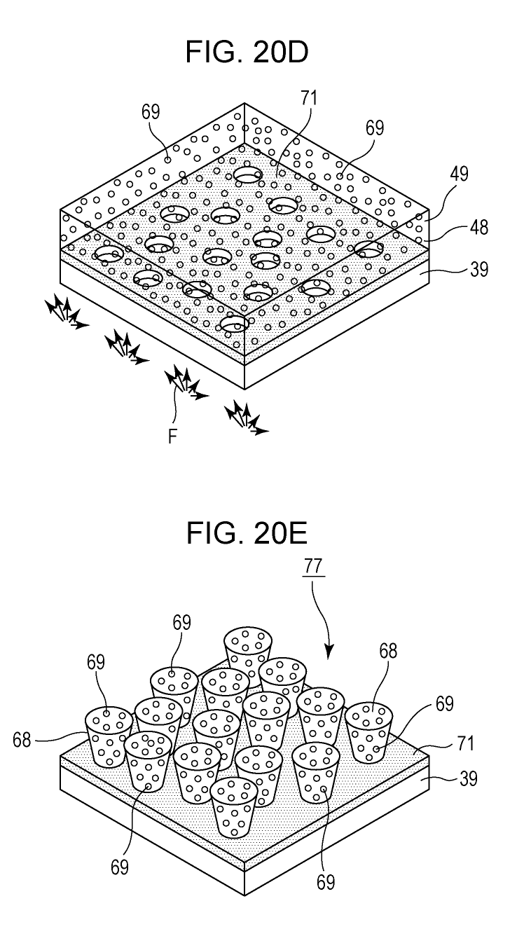

FIG. 18 is a perspective view of a liquid crystal display device of the present embodiment. FIG. 19 is a cross-sectional view of the liquid crystal display device. FIGS. 20A to 20E are perspective views showing a manufacturing process of the viewing angle widening film of the present embodiment according to the sequence.

In FIGS. 18, 19, and 20A to 20E, the same reference numerals are given to the common components with those in the drawings used in the first to third embodiments, and thus detailed description thereof will be omitted.

In the third embodiment, the plurality of light diffusion sections 68 are disposed regularly. In contrast, in the viewing angle widening film 77 of the present embodiment, as shown in FIGS. 18 and 19, a plurality of light diffusion sections 68 are disposed randomly in which the light scattering bodies 69 which scatter light are dispersed. Accordingly, although the pitch between adjacent light diffusion sections 68 are not constant, the average pitch obtained by averaging the pitches between the adjacent light diffusion sections 68 is set to, for example, 25 μm. Other configurations are the same as in the third embodiment.

In the manufacturing process of the viewing angle widening film 77 of the present embodiment, as shown in FIG. 20B, the photo mask 78 used in forming the light shielding layer 71 has a plurality of light shielding patterns 73 of a circular shape which are disposed randomly. In designing the photo mask 78, the following method or the like is used. First, the light shielding patterns 73 are regularly arranged at a constant pitch. Next, the reference position data of each light shielding pattern 73 such as, for example, the center points of the light shielding pattern 73 is made to be fluctuated and the position of the light shielding pattern 73 is made to vary using a random function. Thus, it is possible to manufacture the photo mask 78 having a plurality of light shielding patterns 73 disposed randomly. The manufacturing process itself of the viewing angle widening film 77 is the same as in the first to third embodiments.

Even in the liquid crystal display device 76 of the present embodiment, it is possible to achieve the same effects as those of the first to third embodiments in which the viewing angle widening film 77 capable of exhibiting a desired light diffusion property in all orientations of a screen can be manufactured without complicating manufacturing processes. Further, the light scattering bodies 69 are disposed in the inside to cause forward scattering to occur and such light diffusion sections 68 are disposed randomly, thereby maintaining the display quality without generating moire caused by the interference between the regular arrangements of the pixels of the liquid crystal panel 4.

### Modification Example of the Fourth Embodiment

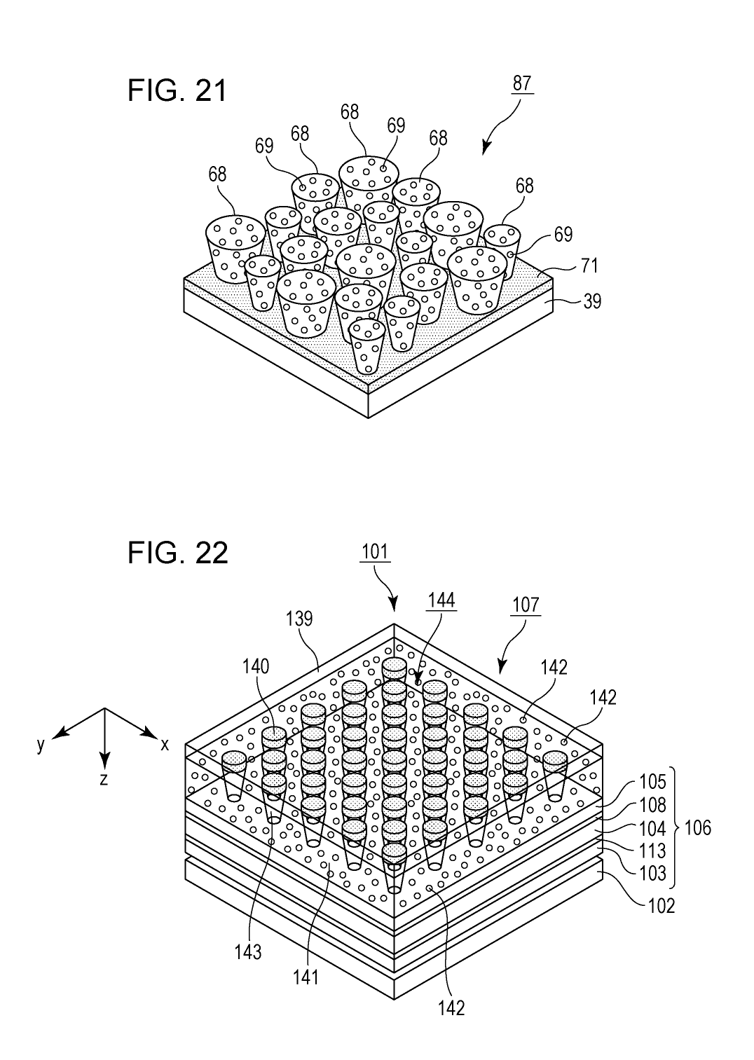

In addition, as shown in FIG. 21, the plurality of light diffusion sections may have different dimensions. In the fourth embodiment, the plurality of light diffusion sections 68 all have the same size and disposed irregularly. In contrast, in the viewing angle widening film 87 of the present embodiment, as shown in FIG. 21, a plurality of light diffusion sections 68 of different sizes are formed and disposed randomly in which the light scattering bodies 69 which scatters light are dispersed. Other configurations are the same as that of the fourth embodiment.

Even in such liquid crystal display device 87 of the present embodiment, the light scattering bodies 69 are disposed in the inside to cause forward scattering to occur and a plurality of such light diffusion sections 68 of different sizes are disposed randomly, thereby maintaining the display quality without generating moire caused by the interference between the regular arrangements of the pixels of the liquid crystal panel 4. In addition, by filling spaces among circular light diffusion sections 68 having a great diameter with circular light diffusion sections 68 having a small diameter, it is possible to increase the arrangement density of the light diffusion sections 68. As a result, it is possible to reduce a proportion of light being shielded by the light shielding layer 71 and to improve the use efficiency of light.

### Fifth Embodiment

FIG. 22 is a perspective view from the obliquely upward direction (viewing side) of a liquid crystal display device of the present embodiment.

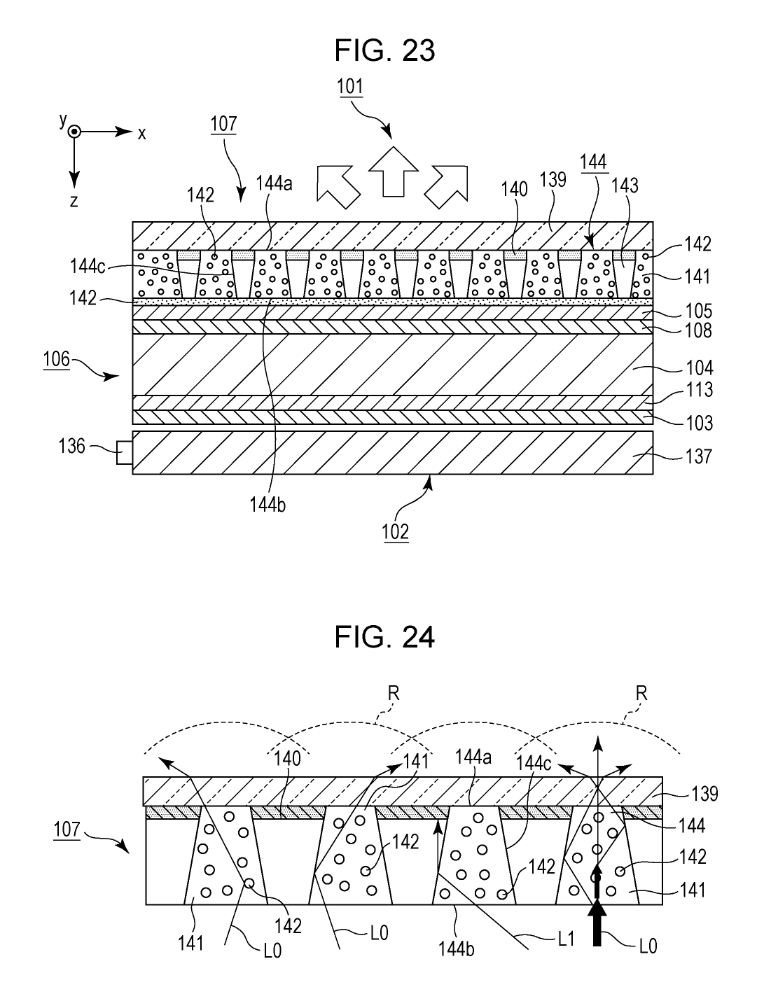

FIG. 23 is a cross-sectional view of the liquid crystal display device of the present embodiment.

As shown in FIGS. 22 and 23, the liquid crystal display device 101 (display device) of the present embodiment includes a backlight 102 (light source), a liquid crystal panel 106 (display body) including a first polarizing plate 103, a first phase difference plate 113, a pair of glass substrates 104 having a liquid crystal layer, a color filter and the like interposed therebetween, a second phase difference plate 108, and a second polarizing plate 105, and a viewing angle widening film (light diffusion member) 107.

Although FIGS. 22 and 23 schematically shows the pair of glass substrates 104 having a liquid crystal layer, a color filter and the like interposed therebetween as a single plate shape, the detailed structure is the same as the FIG. 3 in the first embodiment.

Hereinafter, the viewing angle widening film 107 will be described in detail.

As shown in FIGS. 22 and 23, the viewing angle widening film 107 includes a substrate 139, a plurality of light shielding layers 140, and a light diffusion sections (transparent resin layer) 141. The plurality of light shielding layers 140 are formed on a first region E1 on one surface (the surface on the side opposite to the viewing side) of the substrate 139. The light diffusion section 141 is formed on a second region E2 other than the first region E1 on one surface of the substrate 139. In other words, the light diffusion section 141 is formed in a region different from the first region E1 on one surface of the substrate 139. As shown in FIG. 23, the viewing angle widening film 107 is fixed on the second polarizing plate 105 by the bonding layer 149 in an attitude in which the side having the light diffusion section 141 provided faces the second polarizing plate 105 and the substrate 139 side faces the viewing side.

As shown in FIG. 22, a plurality of light shielding layers 140 are formed so as to be scatteringly arranged on one surface (the surface on the side opposite to the viewing side) of the substrate 139. In the present embodiment, the planar shape of the light shielding layer 140 when viewed from the normal direction of the substrate 139 is circular. The plurality of light shielding layers 140 are disposed regularly. Here, an x-axis is defined as a predetermined direction in the plane parallel to the screen of the of the liquid crystal panel 104, a y-axis is defined as the direction perpendicular to the x-axis in the plane, and a z-axis is defined as the thickness direction of the liquid crystal display device 101. Among the plurality of light shielding layers 140, the light shielding layer 140 of each column aligned in the y-axis direction are disposed at a constant pitch, and the light shielding layer 140 of each row aligned in the x-axis direction are disposed at a constant pitch. Further, the light shielding layers 140 of predetermined columns aligned in the y-axis direction and the light shielding layers 140 of columns adjacent to the columns in the x-axis direction are disposed at positions each shifted by ½ pitch in the y-axis direction.

As an example, the light shielding layer 140 is configured of a layer made of pigments, dyes, resins, or the like of black having light absorbing property and photosensitivity such as a black resist containing carbon black. In a case of using resins or the like containing the carbon black, since the film constituting the light shielding layer 140 can be deposited by the printing process, it is possible to achieve an advantage in which the use amount of a material is reduced and the throughput is high. Other than the above materials, metallic films such as multilayer films of chromium (Cr) or Cr/Cr oxides may be used. In a case of using this kind of metallic films or multilayer films, the optical density of these films are high, so an advantage is obtained in which sufficient light is absorbed in a thin film.

In the present embodiment, as an example, the diameter of each light shielding layer 140 is 10 μm, and the pitch between the adjacent light shielding layers 140 is 20 μm.

The light diffusion section 141 is formed on one surface of the substrate 139. The light diffusion section 141 is formed of, for example, an organic material having optical transparency and photosensitivity such as acrylic resins, epoxy resins or the like.

Further, the total light transmittance of the light diffusion section 141 is preferably 90% or more on the provision of JIS K7361-1. If the total light transmittance is 90% or more, the sufficient transparency is achieved. The total width of the light diffusion section 141 is set to be sufficiently larger than the width of the light shielding layer 140. In a case of the present embodiment, the thickness of the light diffusion section 141 is about 25 μm as an example, and the thickness of the light shielding layer 140 is about 150 nm as an example.

Hollow portions 143, having a shape of which the cross-sectional area when it is cut along a plane parallel to one surface of the substrate 139 is large on the light shielding layer 140 side and the cross-sectional area gradually reduces (decreased) as being away from the light shielding layer 140, are formed in the formation region of the light shielding layer 140 in the light transmission member 144. In other words, the hollow portions 143 are partitioned by the light diffusion sections 141 and have the shape of a truncated cone, a so-called forward tapered shape as viewed from the substrate 139 side. For example, air is present in the inside of the hollow portions 143. Portions other than the hollow portions 143, that is, the light diffusion sections 141 in which a transparent resin is continuously present is portions contributing to the transmission of light. Accordingly, in the following description, portions other than the hollow portions 143 of the light transmission member 144 are also referred to as light diffusion section 141.

In the light diffusion section 141, a plurality of light scattering bodies 142 which weakly scatter (forward scattering) the light incident from the light incident end surface 144b are dispersively disposed. The light scattering bodies 142 are particles (small pieces) made of a constituent material having a refractive index different from the material constituting the light diffusion section 141. The light scattering bodies 142 may be mixed randomly and dispersed in the inside of the light diffusion section 141. The light scattering bodies 142 may be formed of, for example, resin pieces, glass beads, or the like. Alternatively, the light scattering bodies 142 may be gas bubbles which are dispersed in the light diffusion section 141. The shape of each light scattering body 142 may have various shapes such as, for example, spherical shapes, elliptic spherical shapes, flat plate shapes, and polygonal cubes.

The sizes of the light scattering bodies 142 may be formed to be, for example, about 0.5 μm to 20 μm, and may be formed such that the size itself is uniform or random.

The light diffusion section 141 is a portion contributing to the transmission of light in the viewing angle widening film 107. In other words, as shown in FIG. 24, while the light incident to the light diffusion section 141 from the light incident end surface 144b is totally reflected on the outer surface side of the side surface 144c of a tapered shape in the light transmission member 144, is forwardly scattered in the inside of the light diffusion section 141 by the large number of light scattering bodies 142 dispersed in the light diffusion section 141, is guided to the inside of the light diffusion section 141 with being almost confined, and emitted from the light emission end surface 141a.

As shown in FIG. 23, since the viewing angle widening film 7 is disposed such that the substrate 139 faces the viewing side, as shown in FIG. 24, out of two opposing surfaces of the light transmission section 144, a small-area surface (surface on the side in contact with the substrate 139) is a light emitting end surface 144a, and a large-area surface (surface opposite to the substrate 139) is a light incident end surface 144b. Further, it is preferable that the inclination angle (angle between the light emitting end surface 144a and the side surface 144c) of the side surface 144c (interface between the light transmission section 144 and the hollow portions 143) of the light transmission section 144 be, for example, about 60 degree or more to less than 90 degree. However, if the inclination angle of the side surface 144c of the light transmission section 144 is an angle with which the loss of the incident light is not so large and the incident light can be sufficiently diffused, the inclination angle is not particularly limited.

In a case of the present embodiment, since air is present in the hollow portions 143, assuming that the light transmission section 144 is made of, for example, a transparent acrylic resin, the side surface 144c of the light transmission section 144 becomes an interface between the transparent acrylic resin and air. Here, the refractive index difference at the interface between the inside and the outside of the light transmission section 144 is larger when the hollow portions 143 are filled with air, as compared to a case when the surroundings of the light transmission section 144 is filled with other common low refractive index materials. Therefore, by Snell's law, an incident angle range in which light is totally reflected on the side surface 144c of the light transmission section 144 is wide. As a result, loss of light is further suppressed and it is possible to obtain a high brightness.

Further, instead of air, an inert gas such as nitrogen may also be filled in the hollow portion 143. Alternatively, the interior of the hollow portions 143 may be a vacuum.

According to the viewing angle widening film 107 of the present embodiment, as shown in FIG. 24, a plurality of light scattering bodies 142 which weakly scatter (forward scattering) the light incident from the light incident end surface 144b are dispersively disposed. Thus, after even the light L0 incident from any position such as a center portion or an end portion of the light incident end surface 144b is incident to the light diffusion sections 141, the light L0 is repeatedly reflected by a large number of the light scattering bodies 142 (forward scattering). Then, the light is emitted from the light emitting end surface 144a as a constant light (uniform light) in a wide angle range R without leaning by a certain emission angle. In this manner, since the viewing angle widening film 7 of the present embodiment makes it possible to diffuse the light uniformly in the wide viewing angle R, thereby performing a uniformly bright display in the wide viewing angle.

In addition, if the amount of the light scattering bodies 142 included in the light diffusion sections 40 is too large, the number of times that light incident from the light incident end surface 144b is reflected by the light scattering bodies 142 is increased and the amount to be emitted from the light emitting end surface 144a is reduced. In other words, the loss of light is increased. The amount of the light scattering bodies 142 included in the light diffusion section 144 may be set to some amount capable of bending the traveling angle of the light incident from the light incident end surface 144b. In other words, by setting appropriately the amount of the light scattering bodies 142 included in the light diffusion section 144, it is possible to reduce the loss of light and to make the diffusion properties to be uniform.

In addition, generally, it has been known that when patterns with regularity such as stripes and lattices are superimposed with each other, if the period of each pattern is slightly shifted, the interference fringe shape (moire) is viewed. For example, if a viewing angle widening film in which a plurality of light diffusion sections are arranged at a constant pitch and a liquid crystal panel in which a plurality of pixels are arranged at a constant pitch are superimposed, there is a possibility that moire is generated between the periodic pattern by the light diffusion sections of the viewing angle widening film and the periodic pattern by the pixels of the liquid crystal panel. In contrast, according to the liquid crystal display device 101 of the present embodiment, even if the plurality of light diffusion sections 141 are arranged regularly, since the light incident from the light incident end surface 144b is emitted with being scattered forwardly by the light scattering bodies 142 within the light diffusion sections 141, the emitted light is irregular, so it is possible to maintain the display quality high, by effectively avoiding the generation of moire (interference fringe).

Further, it is desirable that the refractive index of the substrate 139 is substantially equal to the refractive index of the light diffusion section 141. For example, this is because there is a possibility that if the refractive index of the substrate 139 is significantly different from the refractive index of the light diffusion section 141, when the light incident from the light incident end surface 144b is about to emit from the light diffusion section 141, there is a possibility that phenomena occurs in which the unwanted refraction and reflection of light is generated at the interface between the light diffusion section 141 and the substrate 139, the desired light diffusion angle is not obtained, and the amount of the emitted light is reduced.

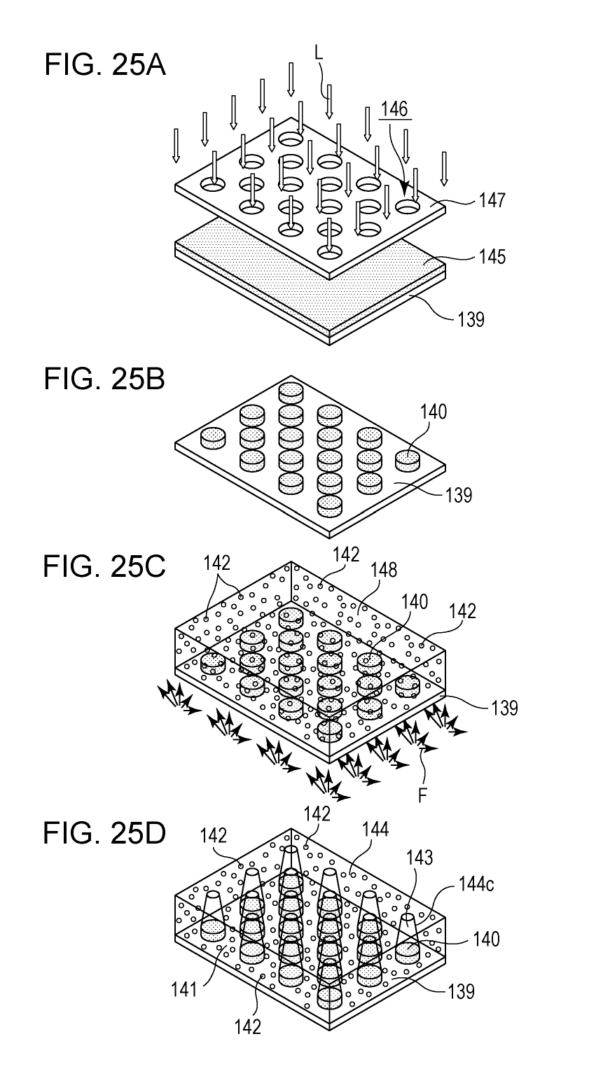

Hereinafter, a method for producing of a liquid crystal display device 101 of the above configuration will be described using FIGS. 25A to 25E.

Hereinafter, the description will be made focusing on the manufacturing process of the viewing angle widening film 107.

First, as shown in FIG. 25A, for example, a substrate 139 of tri-acetyl cellulose of a thickness of 100 μm is prepared, and black negative resists containing carbon as a light shielding layer material are applied on one surface of the substrate 139 by using the spin coating method to form a coating film 145 having a film thickness of 150 nm.

Next, the substrate 139 having the above coating film 145 formed is placed on a hot plate and the coating film 145 is pre-baked at a temperature of 90° C. Thus, the solvent in the black negative resist is volatilized.

Next, using an exposure apparatus, exposure is performed by the coating film 145 being irradiated with L through a photo mask 147 having a plurality of opening patterns 146 of circular planar shape provided therein. At this time, an exposure apparatus using a mixed ray of an i ray of a wavelength of 365 nm, an h ray of a wavelength of 404 nm, and a g ray of a wavelength of 436 nm is used. The exposure amount is 100 mJ/cm².

After exposure is performed using the above photo mask 147, a coating film 145 made of a black negative resist is developed using a designated developing solution and dried at 100° C., and thus as shown in FIG. 25B, a plurality of light shielding layers 140 of a circular planar shape are formed on one surface of the substrate 139. In a case of the present embodiment, in the next process, the transparent negative resist is exposed by using the light shielding layers 140 made of a black negative resist as a mask to form a hollow portion 143. Therefore, the position of the opening patterns 146 of the photo mask 147 correspond to the formation position of the hollow portions 143.

The light shielding layers 140 of a circular shape correspond to the first region (hollow portion 143) which is a non-formation region of the light transmission section 144 of the next process. The plurality of opening patterns 146 are, for example, all circular patterns of a diameter of 10 μm. The distance (pitch) between adjacent opening patterns 146 is for example, 20 μm. It is desirable that the pitch of the opening pattern 146 be smaller than the distance (pitch, for example, 150 μm) between pixels of the liquid crystal panel 104. Thus, at least one light shielding layers 140 is formed within the pixel, so it is possible to achieve a wide viewing angle when combined with, for example, a liquid crystal panel having a small pixel pitch used in a mobile device.

Although the light shielding layers 140 are formed by a photolithography method using the black negative resist in the present embodiment, instead of this configuration, if a photo mask is used in which the opening pattern 146 and the light shielding pattern of the present embodiment are reversed, it is possible to use a positive resist having a light absorption property. Alternatively, light shielding layers 140 may be directly formed using a vapor deposition method, a printing method, or the like.

Next, as shown in FIG. 25C, a transparent negative resist in which a large number of light scattering bodies 142 such as, for example, glass beads are dispersed in advance in an acrylic resin is applied on the upper surface of the light shielding layer 140 by using a spin coating method to form a coating film 148 (negative type photosensitive resin layer) of a film thickness of 50 μm. Next, the substrate 139 having the above coating film 148 formed is placed on a hot plate and the coating film 148 is pre-baked at a temperature of 95° C. Thus, the solvent in the transparent negative resist is volatilized.

Next, exposure is performed by the coating film 148 being irradiated with the light F by using the light shielding layer 140 as a mask from the substrate 139 side. At this time, an exposure apparatus using a mixed ray of an i ray of a wavelength of 365 nm, an h ray of a wavelength of 404 nm, and a g ray of a wavelength of 436 nm is used. The exposure amount is 500 mJ/cm².

Thereafter, the substrate 139 on which the coating film 148 is formed is placed on a hot plate and the post-exposure bake (PEB) of the coating film 148 is performed at a temperature of 95° C.

Next, the coating film 148 made of a transparent negative resist is developed using a designated developing solution and post-baked at 100° C., as shown in FIG. 25D, and thus light diffusion sections 141 which has a plurality of hollow portions 143 and in which light scattering bodies 142 are dispersed in the inside are formed on one surface of the substrate 139. In the present embodiment, as shown in FIG. 25C, the exposure is performed using the diffusion light, so the transparent negative resist constituting the coating film 148 is exposed radially so as to spread outwardly from the non-formation region of the light shielding layer 140. Thus, the hollow portions 143 of a forward tapered shape are formed, and the light transmission section 144 has an inversely tapered shape. It is possible to control the inclination angle of the side surface 144c of the light transmission section 144 by a diffusion degree of the diffusion light.

As light F to be used herein, it is possible to use parallel light, diffusion light, or light of which the light strength at a certain emission angle is different from the strength at the other emission angles, that is, light having strength or weakness at a certain emission angle. In a case of using the parallel light, the inclination angle of the side surface 144c of the light transmission section 144 has a single inclination angle, for example, 60 degree or more to less than 90 degree. In a case of using the diffusion light, the inclination angle is continuously changed, and the inclined surface has a curved cross-sectional shape. In a case of using the light having strength or weakness at a certain emission angle, the inclined surface has a slope angle corresponding to the strength or weakness. In this manner, it is possible to adjust the inclination angle of the side surface 144c of the light transmission section 144. Thus, it is possible to adjust the light diffusing property of the viewing angle widening film 107 in order to obtain the viewability of interest.

In addition, as one of means for irradiating the substrate 139 by using the parallel light emitted from the exposure apparatus as light F, for example, a diffusing plate of about 50 haze is disposed on the light path of the light emitted from the exposure apparatus, so light is irradiated through the diffusing plate.

Through the above process of FIGS. 25A to 25D, the viewing angle widening film 107 of the present embodiment is completed. The total light transmittance of the viewing angle widening film 107 is preferably 90% or more. If the total light transmittance is 90% or more, the sufficient transparency is achieved and the sufficient optical performance required for the viewing angle widening film 7 can be exhibited. The total light transmittance is due to the provision of JIS K7361-1. In addition, in the present embodiment, although an example of using the resist of the liquid type is presented, instead of this configuration, the film-like resist may be used.

Finally, as shown in FIG. 23, the viewing angle widening film 107 that has been completed is affixed to the liquid crystal panel 106 through a bonding layer 128, or the like, in a state where the substrate 139 faces the viewing side and a light transmission section 144 is opposed to the second polarizing plate 105.

Through the above process, the liquid crystal display device 101 of the present embodiment is completed.

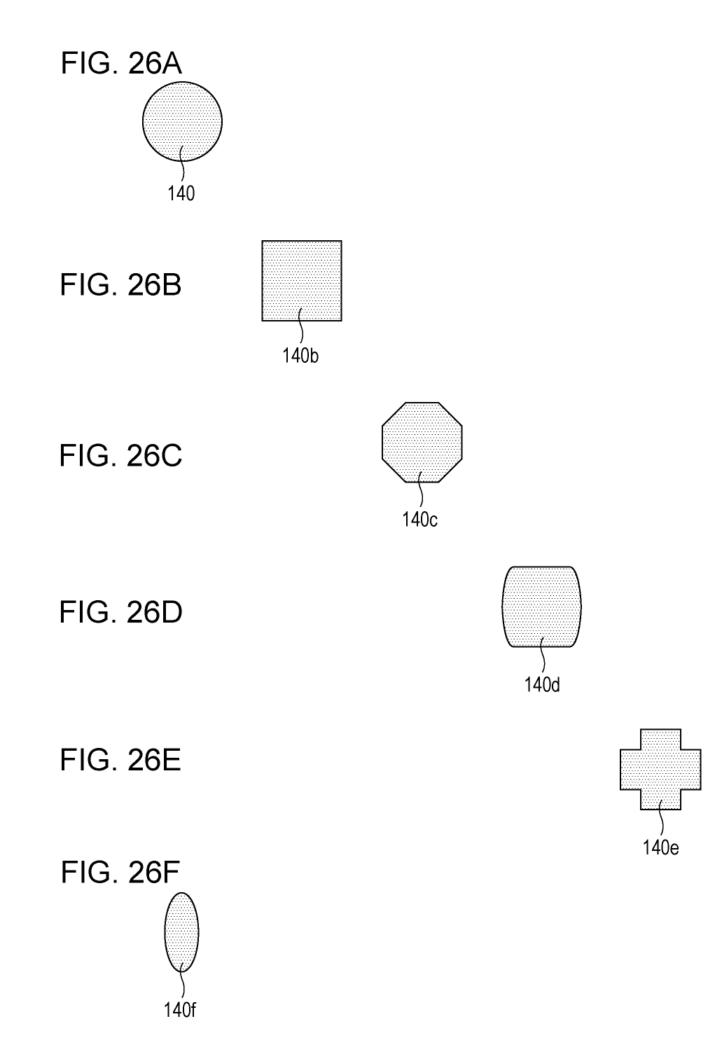

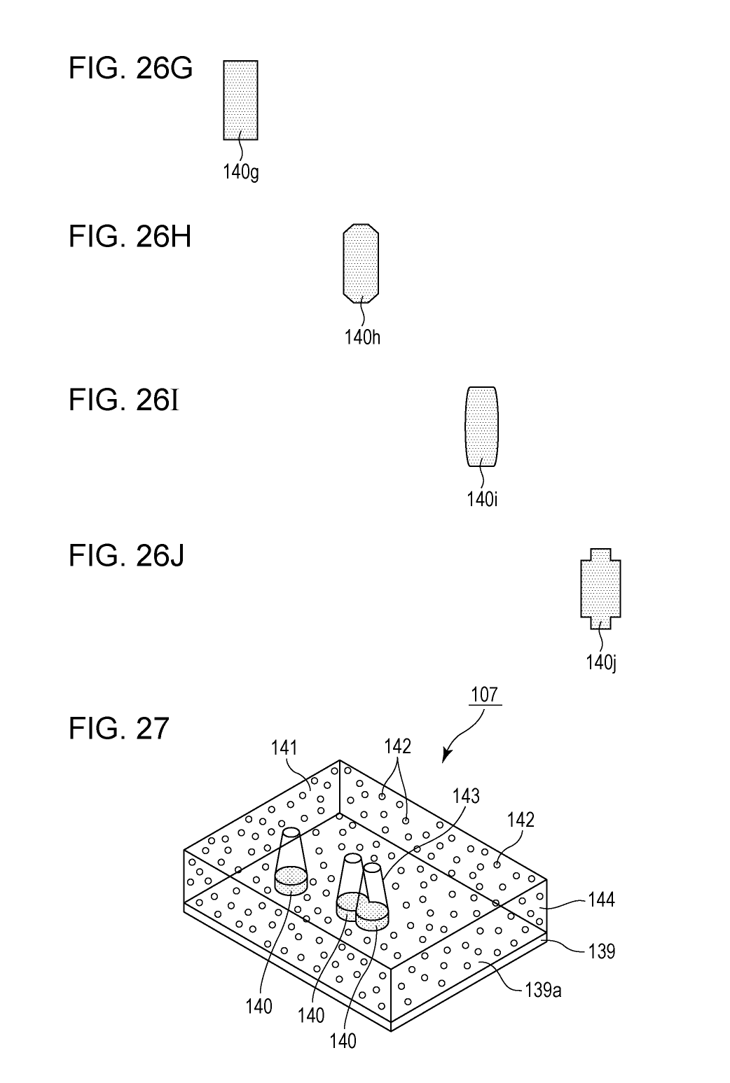

Further, although an example of the light shielding layer 140 of which the planar shape is circular is shown in the present embodiment as shown in FIG. 26A, for example, as shown in FIG. 26B, the light shielding layer 140b of which the planar shape is a square may be used. Alternatively, as shown in FIG. 26C, the light shielding layer 140c of which the planar shape is a regular octagon may be used. Alternatively, as shown in FIG. 26D, the light shielding layer 140d of the shape in which two opposing sides of the square are curved outwards may be used. Alternatively, as shown in FIG. 26E, the light shielding layer 140e of the shape in which two rectangles are crossed in two directions perpendicular to each other may be used. Alternatively, as shown in FIG. 26F, the light shielding layer 140f of the shape of an elongated oval may be used. Alternatively, as shown in FIG. 26G, the light shielding layer 140g of the shape of an elongated rectangle may be used. Alternatively, as shown in FIG. 26H, the light shielding layer 140h of the shape of an elongated octagon may be used. Alternatively, as shown in FIG. 26I, the light shielding layer 140i of the shape in which two opposing sides of the elongated rectangle are curved outwards may be used. Alternatively, as shown in FIG. 26J, the light shielding layer 140j of the shape in which two rectangles of different aspect ratios are crossed in two directions perpendicular to each other may be used.

### Modification Example of the Fifth Embodiment

In addition, as shown in FIG. 27, a portion of the plurality of light shielding layers 140 formed on one surface 139a of the substrate 139 may be formed so as to be connected to each other. In other words, in the example shown in FIG. 27, the mutually adjacent light shielding layers 140 are connected to each other. Incorporating irregularly such a configuration makes the emitted light to further randomly emit, so it is possible to effectively prevent the generation of moire (interference fringes).

### Sixth Embodiment

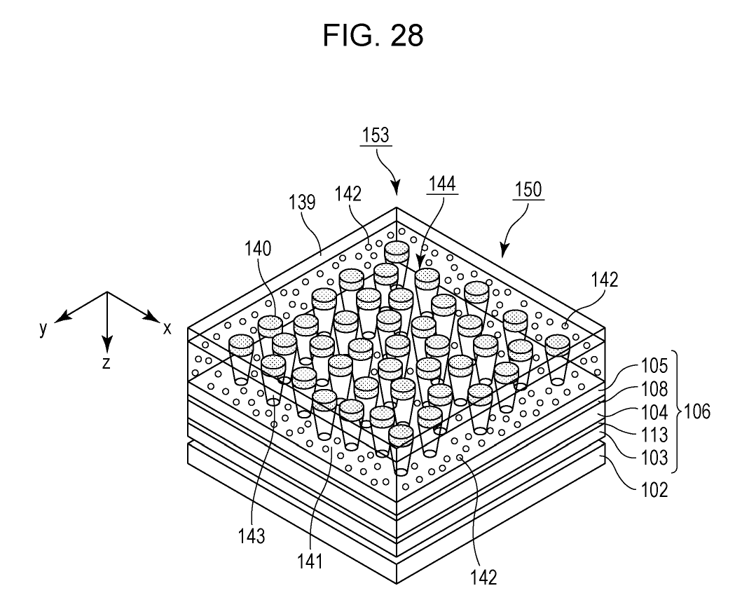

Hereinafter, a sixth embodiment of the present invention will be described using FIGS. 28 to 30C.

The basic configuration of a liquid crystal display device of the present embodiment is the same as in the fifth embodiment, and the arrangement of a light shielding layer of a viewing angle widening film is different from that of the fifth embodiment. Therefore, in the present embodiment, the description of the basic configuration of the liquid crystal display device is omitted, and only the viewing angle widening film will be described.

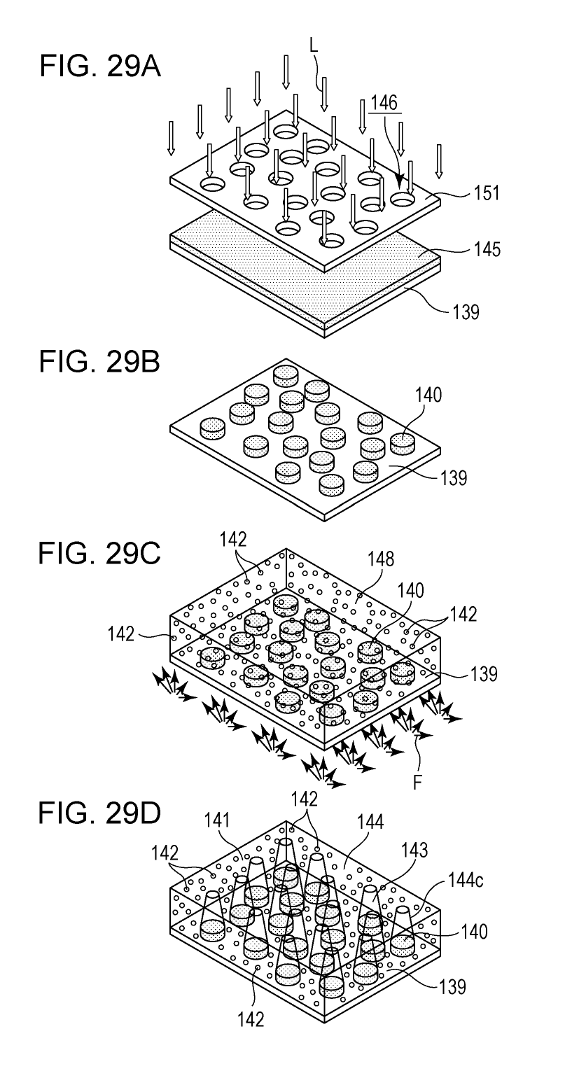

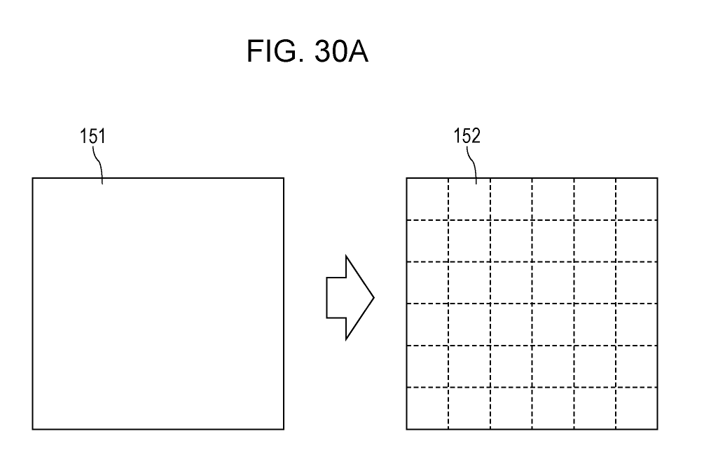

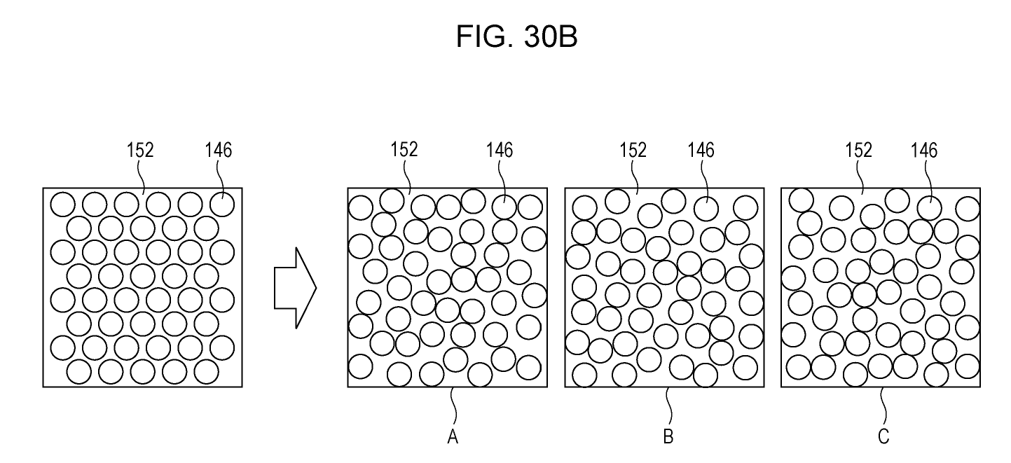

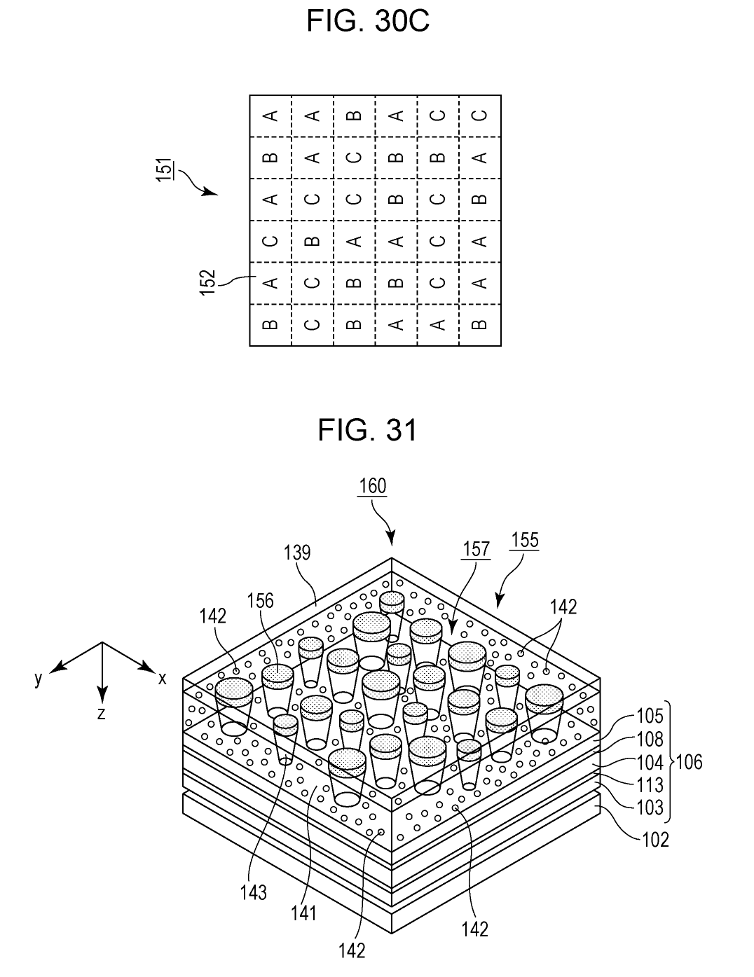

FIG. 28 is a perspective view of a liquid crystal display device of the present embodiment. FIGS. 29A to 29D are cross-sectional views showing a manufacturing process of the viewing angle widening film of the present embodiment according to the sequence. FIGS. 30A to 30C are views for explaining the arrangement of the light shielding layer of the viewing angle widening film of the present embodiment.

In FIGS. 28 to 30C, the same reference numerals are given to the common components with those in the drawings used in the first embodiment, and thus detailed description thereof will be omitted.

In the viewing angle widening film 107 of the fifth embodiment, a plurality of light shielding layers 140 of which planar shape is circular are disposed randomly on the substrate. In contrast, in a viewing angle widening film 150 of the present embodiment, as shown in FIG. 28, a plurality of light shielding layers 140 of which planar shape is circular are disposed randomly on the substrate 139. Along with it, a plurality of hollow portions 143 formed in the same positions as the plurality of light shielding layer 140 are also randomly disposed on the substrate 139.

As shown in FIG. 29A to FIG. 29D, the manufacturing process of the viewing angle widening film 150 of the present embodiment is similar to that of the fifth embodiment. However, the photo mask 151 shown in FIG. 29A which is used in the exposure process of the black negative resist for forming a light shielding layer is different from the photo mask 147 used in the fifth embodiment. The plurality of opening patterns 146 of a circular planar shape are disposed randomly in the photo mask 151 of the present embodiment, as shown in FIG. 29A. By the coating film 145 of the black negative resist being irradiated with the light L through the photo mask 151, and being developed, as shown in FIG. 29B, the plurality of light shielding layers 140 that are disposed randomly on the substrate 139 are formed.

Here, an example of a method for designing a photo mask 51 in which a plurality of opening patterns 146 are disposed randomly is described.

First, as shown in FIG. 30A, the entire photo mask 151 is divided into regions 152 of m×n pieces (for example, 36 pieces) formed of vertical m pieces (for example, six) and horizontal n pieces (for example, six).

Next, as shown in FIG. 30B, in one region 152 obtained by the division in the previous process, patterns are created in which circles corresponding to the shapes of the opening patterns 146 are disposed so as to be close-packed (figure on the left side of FIG. 30B). Next, a plurality of types (for example, patterns of three types of A, B, and C) of position data is created (three figures on the right side of FIG. 30B) by having a fluctuation in position data which is a reference of the position of each circle, such as, for example, the central coordinate of each circle by using a random function.

Next, as shown in FIG. 30C, the plurality of types of position data A, B, and C produced in the previous process are randomly assigned in the area of m×n. For example, each position data A, B, and C is assigned in each region 152 such that the position data A, the position data B and the position data C appear randomly in the regions 152 of 36. Therefore, if viewing the photo mask 151 for each region 152, the arrangement of the opening patterns 146 of each region 152 is fitted into any pattern of the position data A, the position data B, and the position data C, and it does not mean that all opening patterns 146 in the entire region are arranged randomly. However, if viewing the photo mask 151 as a whole, the plurality of opening patterns 146 are disposed randomly.

Even in the viewing angle widening film 150 of the present embodiment, it is possible to achieve the same effect as that of the fifth embodiment in which destruction of the light transmission section 144 caused by an external force or the like hardly occurs and desired light diffusion function can be maintained without the transmittance of light being lowered, a precise alignment operation is not required, and it is possible to shorten the time required for manufacturing.

Generally, it has been known that when patterns with regularity such as stripes and lattices are superimposed with each other, the interference fringe shape (moire) caused by the shift of the periods thereof is viewed.

For example, if a viewing angle widening film in which a plurality of light diffusion sections are arranged in a matrix shape and a liquid crystal panel in which a plurality of pixels are arranged in a matrix shape are superimposed, there is a possibility that if moire is generated between the periodic pattern by the light diffusion section of the viewing angle widening film and the periodic pattern by the pixels of the liquid crystal panel. In contrast, according to the liquid crystal display device 153 of the present embodiment, since the plurality of light shielding layers 140 are disposed randomly in a plane, and the light scattering bodies 142 are dispersively disposed in the inside of the light diffusion section 141 through which light is transmitted, it is possible to maintain the display quality without generating moire caused by the interference between the regular arrangements of the pixels of the liquid crystal panel 4.

Further, in the present embodiment, even if the planar arrangement of the hollow portions 143 is random, the volume of each hollow portion 143 is the same, so the volume of the resin to be removed in developing the light diffusion section 141 is constant. Therefore, in the process of manufacturing each hollow portion 143, the developing speed of each hollow portion 143 is constant, and a desired tapered shape can be formed. As a result, the uniformity of the fine shape of the viewing angle widening film 150 is increased, and the yield is improved.

### Seventh Embodiment

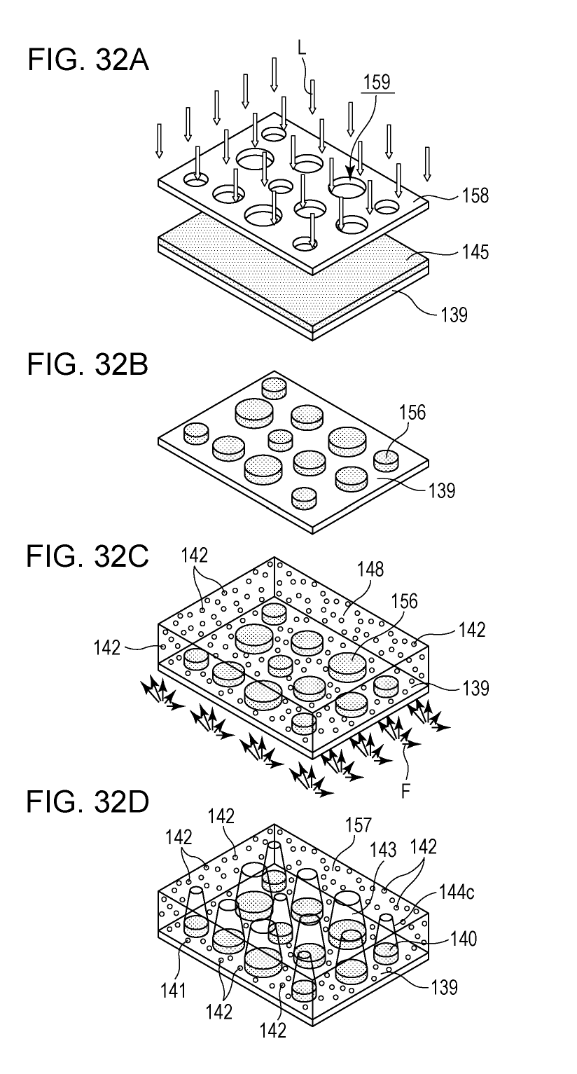

Hereinafter, a seventh embodiment of the present invention will be described using FIGS. 31 to 32D.

The basic configuration of a liquid crystal display device of the present embodiment is the same as those of the fifth and sixth embodiments, but the light shielding layer of the viewing angle widening film is different from the fifth and sixth embodiments. Therefore, in the present embodiment, the description of the basic configuration of the liquid crystal display device is omitted, and only the viewing angle widening film is described.

FIG. 31 is a cross-sectional view showing a liquid crystal display device of the present embodiment. FIGS. 32A to 32D are diagrams for explaining a method for producing of the viewing angle widening film of the present embodiment.

Further, in FIGS. 31, 32A to 32D, the same reference numerals are given to the common components with those in the drawings used in the fifth and sixth embodiments, and thus detailed description thereof will be omitted.

In the fifth and the sixth embodiments, the plurality of light shielding layers 140 all have the same dimension. In contrast, in the viewing angle widening film 155 of the present embodiment, as shown in FIG. 31, the dimensions (diameters) of the plurality of light shielding layers 156 are different. For example, the diameters of the plurality of light shielding layer 156 are distributed in a range of 10 μm to 25 μm. In other words, the plurality of light shielding layers 156 have a plurality of types of dimensions.

Further, the plurality of light shielding layers 156 are disposed randomly in a plane, similar to the sixth embodiment. Further, among the plurality of hollow portions 143, the volume of at least one of the hollow portions 143 is different from the volumes of other hollow portions 143. Other configurations are the same as those of the fifth embodiment.

The manufacturing process of the viewing angle widening film 155 is the same as in the fifth embodiment, but as shown in FIG. 32A, it is different from the fifth embodiment in that the photo mask 158 used in forming the light shielding layer 156 has a plurality of opening patterns 159 of different dimensions.

Even in the viewing angle widening film 155 of the present embodiment, it is possible to achieve the same effect as that of the fifth embodiment in which destruction of the light diffusion section 157 caused by an external force or the like hardly occurs and desired light diffusion function can be maintained without the light transmittance lowered, a precise alignment operation is not required, and it is possible to shorten the time required for manufacturing.

In a case of the present embodiment, as well as that the light scattering bodies 142 are dispersively disposed in the inside of the light diffusion section 141 through which light is transmitted, and the plurality of light shielding layers 156 are randomly disposed, the sizes of the light shielding layers 156 are different, so it is possible to more reliably suppress moire fringes caused by the diffraction phenomena of light. Further, since the volume of at least one of the hollow portions 143 is different from the volumes of other hollow portions 143, it is possible to raise light diffusion property.

### Eighth Embodiment

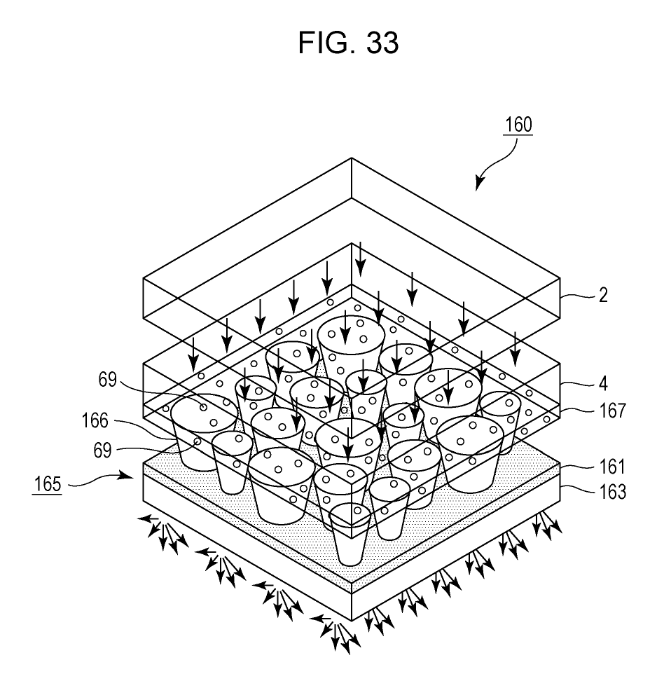

Hereinafter, an eighth embodiment of the present invention will be described using FIGS. 33 to 35.

In a liquid crystal display device of the present embodiment, light scattering bodies are dispersed in the bonding layer, instead of dispersing the light scattering bodies in the inside of the light diffusion section shown in the modification example of the fourth embodiment. Accordingly, in the present embodiment, the description of a basic configuration of the liquid crystal display device is omitted and only the viewing angle widening film will be described.

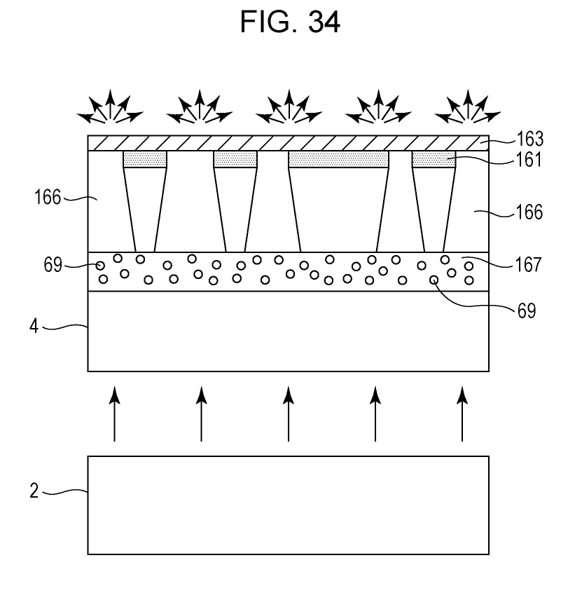

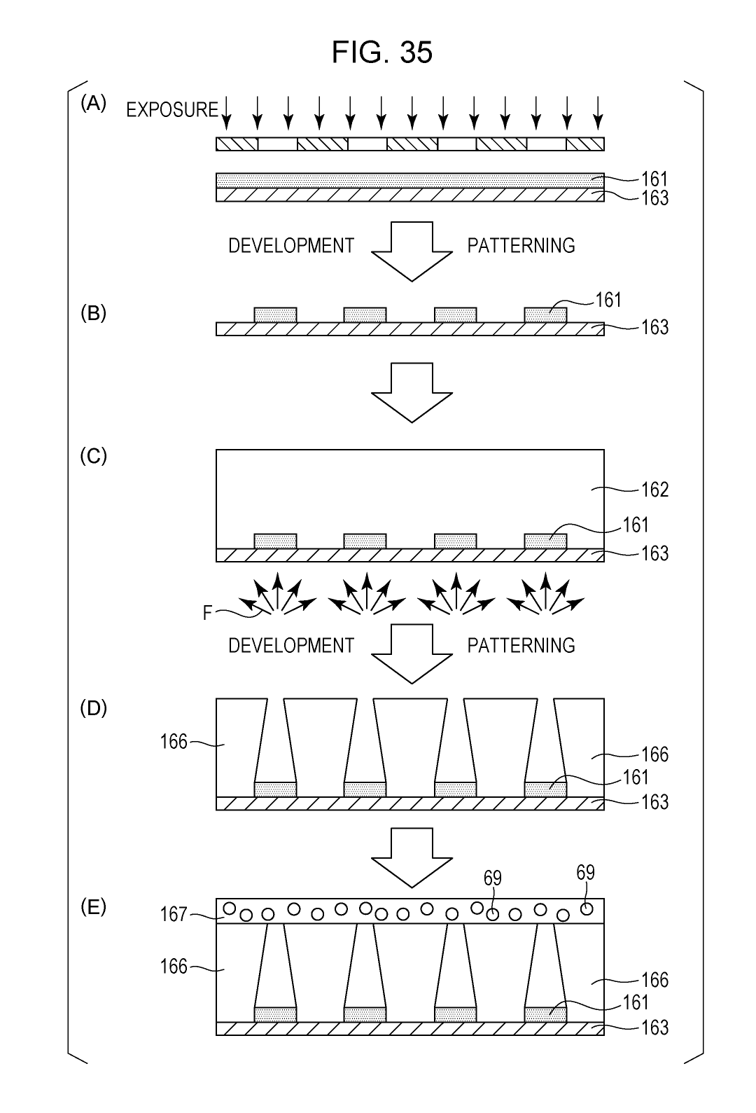

FIG. 33 is a cross-sectional view showing a liquid crystal display device of the present embodiment. FIG. 34 is a cross-sectional view of the liquid crystal display device. FIG. 35 is a perspective view showing a manufacturing process of the viewing angle widening film of the present embodiment according to the sequence.

Further, in FIGS. 33, 34, and 35, the same reference numerals are given to the common components with those in the drawings used in the fourth embodiment, and thus detailed description thereof will be omitted.

In the modification example of the fourth embodiment, a plurality of types of light diffusion sections 68 of different sizes are randomly disposed and light scattering bodies 69 which scatter the light in each of the light diffusion sections 68 are dispersed. In contrast, in the viewing angle widening film 165 of the present embodiment, as shown in FIGS. 33 and 34, without the light scattering bodies 69 being disposed in each of the light diffusion sections 166, the light scattering bodies 69 are dispersively disposed in a bonding layer 167 which bonds the viewing angle widening film 165 with the liquid crystal panel (display body) 4. Other configurations are the same as the fourth embodiment.

Next, as shown in (C) of FIG. 35, in the manufacturing process of the viewing angle widening film 165 of the present embodiment, for example, a transparent negative resist is applied on the upper surface of the light shielding layer 161 subjected to patterning by using a spin coating method to form a coating film 162 (negative type photosensitive resin layer) of a film thickness of 50 μm.

Next, the substrate 163 having the above coating film 162 formed is placed on a hot plate and the coating film 162 is pre-baked at a temperature of 95° C. Thus, the solvent in the transparent negative resist is volatilized.

Next, exposure is performed by the coating film 162 being irradiated with the diffusion light F by using the light shielding layer 161 as a mask from the substrate 163 side. At this time, an exposure apparatus using a mixed ray of an i ray of a wavelength of 365 nm, an h ray of a wavelength of 404 nm, and a g ray of a wavelength of 436 nm is used. The exposure amount is 500 mJ/cm².

In the exposure process, parallel light or diffusion light is used.

Next, the coating film 162 made of a transparent negative resist is developed using a designated developing solution and post-baked at a temperature of 100° C., as shown in (D) of FIG. 35, and thus a plurality of light diffusion sections 166 are formed.

Then, a bonding layer (adhesive layer) 167 in which light scattering bodies 69 such as a large number of glass beads are dispersed in the inside, for example, in acrylic resins is formed by being overlapped with the light diffusion sections 166.

Through the above process, the viewing angle widening film (light diffusion body) 165 of the present embodiment is completed.

Finally, as shown in FIG. 34, the liquid crystal display device 160 of the present embodiment is completed by bonding the viewing angle widening film 165 that has been completed to the liquid crystal panel (displaying body) 4 through the bonding layer 167 and by forming a backlight 2 on the rear surface side of the liquid crystal panel 4.

Even in the liquid crystal display device 160 of the present embodiment, it is possible to achieve an effect in which the viewing angle widening film 165 capable of exhibiting a desired light diffusion property in all orientations of a screen can be manufactured without complicating manufacturing processes. Further, the light scattering bodies 69 are disposed in the inside of the bonding layer 167 to cause forward scattering to occur, thereby maintaining the display quality without generating moire caused by the interference between the regular arrangements of the pixels of the liquid crystal panel 4.

### Modification Example of the Eighth Embodiment

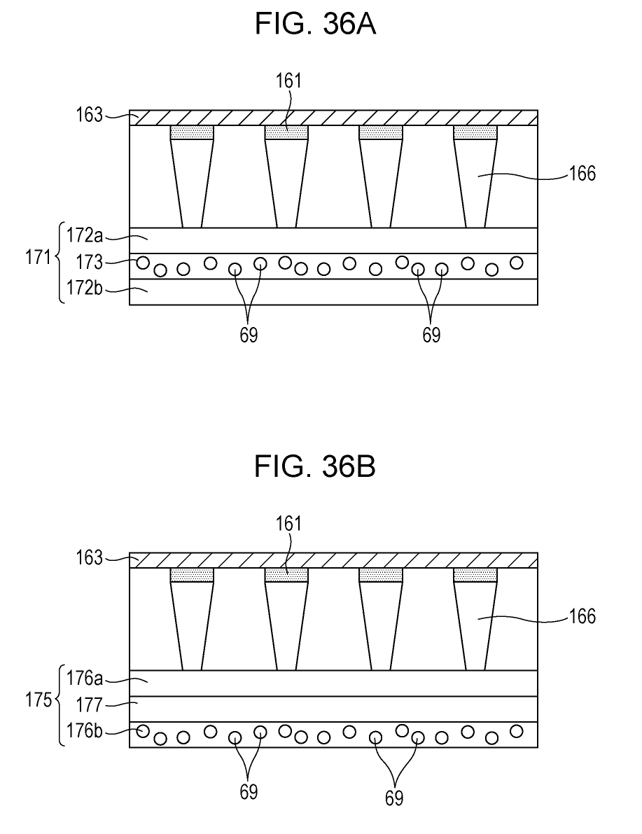

In addition, FIGS. 36A and 36B show a configuration example of a boding layer in which light scattering bodies are dispersed. In FIG. 36A, the bonding layer 171 is configured of two adhesive layers 172a and 172b, and a diffusion film 173 disposed between the adhesive layers 172a and 172b. A large number of light scattering bodies 69 such as, for example, glass beads are dispersed in the inside of the diffusion film 173.

In addition, in FIG. 36B, the bonding layer 175 is configured of two adhesive layers 176a and 176b, and a transparent film 177 disposed between the two adhesive layers 176a and 176b. A large number of light scattering bodies 69 such as, for example, glass beads are dispersed in the inside of the adhesive layer 176b on one side.

Even with the bonding layers 171 and 175 respectively shown in FIGS. 36A and 36B, the display quality can be maintained without generating moire caused by the interference between the regular arrangements of the pixels of the liquid crystal panel.

### Ninth Embodiment

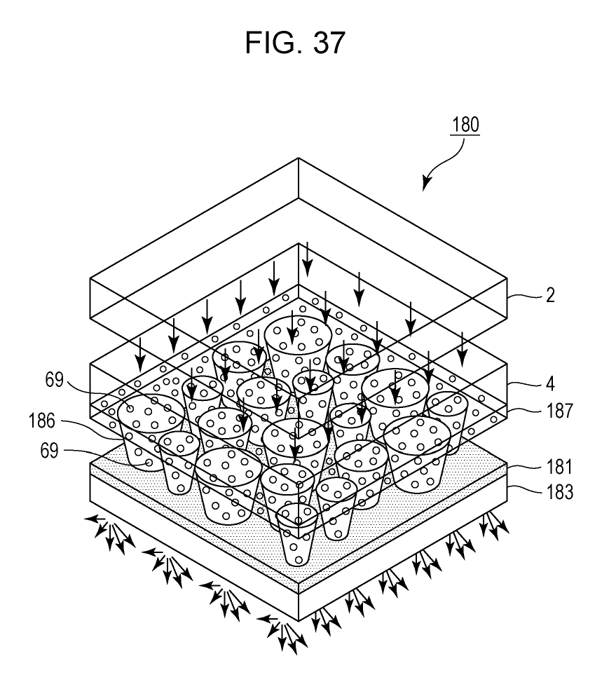

Hereinafter, a ninth embodiment of the present invention will be described using FIGS. 37 to 39.

In a liquid crystal display device of the present embodiment, light scattering bodies are dispersed even in light diffusion sections, in addition to dispersing the light scattering bodies inside a bonding layer shown in the eighth embodiment. Accordingly, in the present embodiment, the description of a basic configuration of the liquid crystal display device is omitted and only the viewing angle widening film will be described.

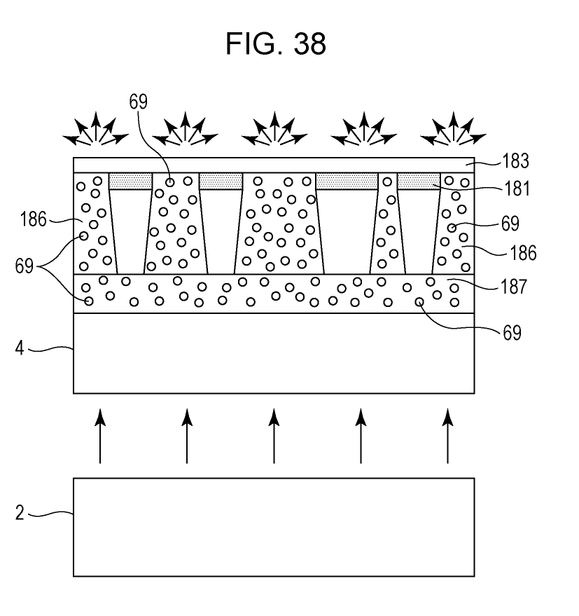

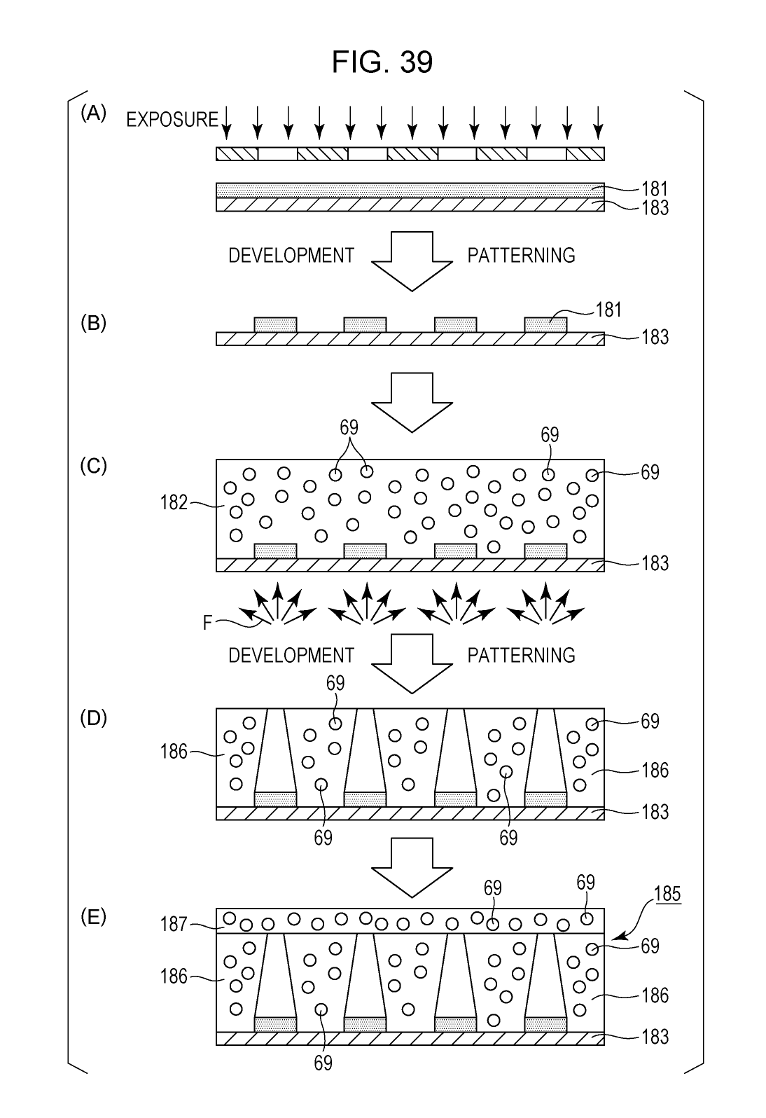

FIG. 37 is a cross-sectional view showing a liquid crystal display device of the present embodiment. FIG. 38 is a cross-sectional view of the liquid crystal display device. FIG. 39 is a cross-sectional view showing a manufacturing process of the viewing angle widening film of the present embodiment according to the sequence.

Further, in FIGS. 37, 38, and 39, the same reference numerals are given to the common components with those in the drawings used in the eighth embodiment, and thus detailed description thereof will be omitted.

In the eighth embodiment, an anything in which light scattering bodies 69 are dispersed in the bonding layer 187 is used. In contrast, in the viewing angle widening film 185 of the present embodiment, as shown in FIGS. 37 and 38, the light scattering bodies 69 are dispersed in the inside of the light diffusion section 186 respectively, and at the same time, the light scattering bodies 69 are dispersed in the bonding layer 187. Other configurations are the same as the eighth embodiment.

Next, in the manufacturing process of the viewing angle widening film 185 of the present embodiment, as shown in (c) of FIG. 39, a transparent negative resist in which a large number of light scattering bodies 69 such as, for example, glass beads are dispersed is applied on the upper surface of the light shielding layer 181 subjected to patterning by using a spin coating method to form a coating film 182 (negative type photosensitive resin layer) of a film thickness of 50 μm.

Next, the substrate 183 having the above coating film 182 formed is placed on a hot plate and the coating film 182 is pre-baked at a temperature of 95° C. Thus, the solvent in the transparent negative resist is volatilized.

Next, exposure is performed by the coating film 182 being irradiated with the diffusion light F by using the light shielding layer 181 as a mask from the substrate 183 side. At this time, an exposure apparatus using a mixed ray of an i ray of a wavelength of 365 nm, an h ray of a wavelength of 404 nm, and a g ray of a wavelength of 436 nm is used. The exposure amount is 500 mJ/cm².

In the exposure process, parallel light or diffusion light is used.

Next, the coating film 182 made of a transparent negative resist is developed using a designated developing solution and post-baked at a temperature of 100° C., as shown in (D) of FIG. 39, and thus a plurality of light diffusion sections 186 in which light scattering bodies 69 are dispersed are formed.

Then, a bonding layer (adhesive layer) 187 in the inside of which light scattering bodies 69 such as, for example, a large number of glass beads are dispersed in acrylic resins is formed by being overlapped with the light diffusion sections 186.

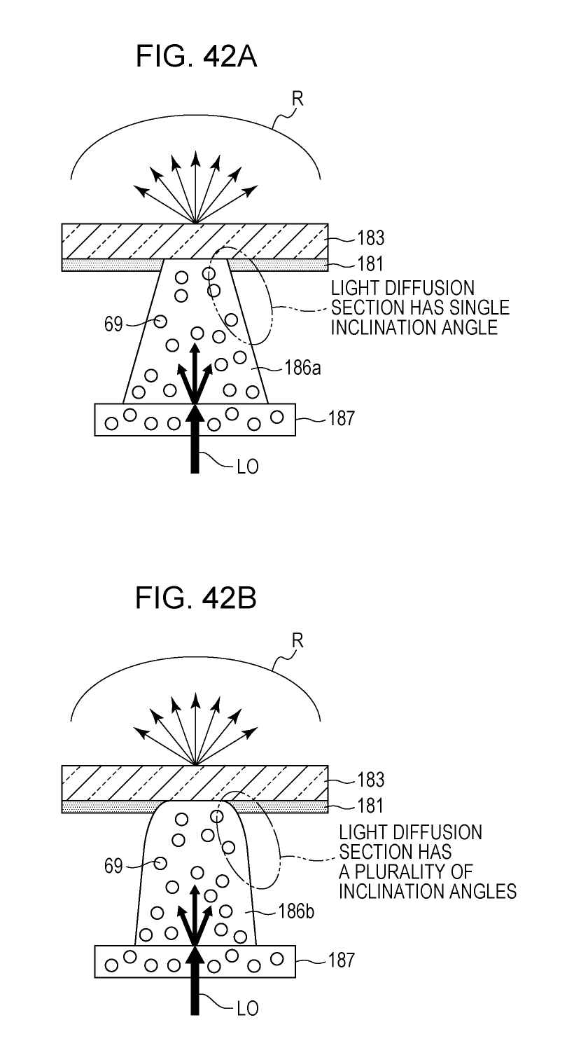

FIG. 42A shows a formation example in a case where a light diffusion section 186a has a single (uniform) inclination angle. Further, FIG. 42B shows a case where a light diffusion section 186b has a plurality of inclination angles (inclination angle is continuously changed).

Comparing these FIGS. 42A and 42B, since more plurality types of emission light can be emitted by the configuration in which the side surfaces of the light diffusion sections 186a have a plurality of inclination angles and the light scattering bodies 69 are mixed, it is preferable that the inclination angles of the light diffusion sections 186 be multiple.

Through the above process, as shown in FIG. 39E, the viewing angle widening film (light diffusion body) 185 of the present embodiment is completed.

Finally, as shown in FIG. 38, the liquid crystal display device 180 of the present embodiment is completed by bonding the viewing angle widening film 185 that has been completed to the liquid crystal panel (displaying body) 4 through the bonding layer 187 and by forming a backlight 2 on the rear surface side of the liquid crystal panel 4.

Even in the liquid crystal display device 180 of the present embodiment shown in FIG. 37, it is possible to achieve an effect in which the viewing angle widening film 185 (FIG. 39E) capable of exhibiting a desired light diffusion property in all orientations of a screen can be manufactured without complicating manufacturing processes. Further, the plurality of light diffusion sections 186 in the inside of which the light scattering bodies 69 are disposed and the bonding layer 187 in the inside of which the light scattering bodies 69 are disposed cause forward scattering to occur, thereby maintaining the display quality without generating moire caused by the interference between the regular arrangements of the pixels of the liquid crystal panel 4.

### Tenth Embodiment

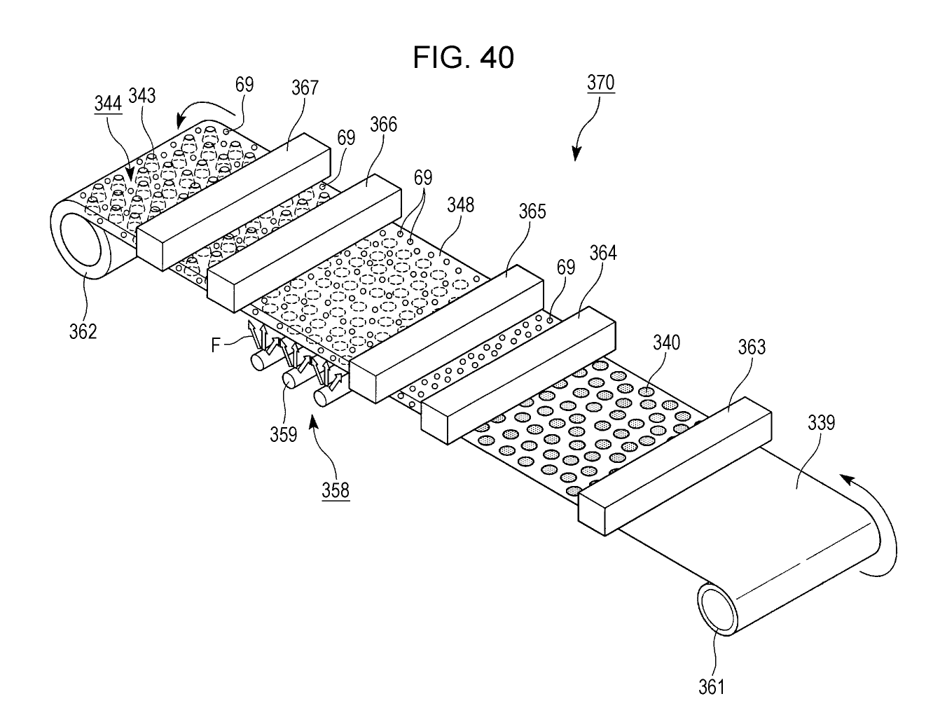

Hereinafter, a tenth embodiment of the present invention will be described using FIG. 40.

In the present embodiment, a modification example of a manufacturing process of a viewing angle widening film (light diffusion member).

FIG. 40 is a schematic configuration diagram showing an example of a manufacturing apparatus of the viewing angle widening film (light diffusion member).

The manufacturing apparatus 370 shown in FIG. 40 conveys a long substrate 339 by a roll-to-roll and performs various processes thereon. Further, the manufacturing apparatus 370 uses a printing method instead of the photolithography method using the photo mask 347 described above, in forming the light shielding section 340.

As shown in FIG. 40, a delivery roller 361 which feeds the substrate 339 is provided at the one end of the manufacturing apparatus 370, and a winding roller 362 which winds the substrate 339 is provided at the other end thereof. The manufacturing apparatus 370 is configured such that the substrate 339 moves toward the winding roller 362 side from the delivery roller 361 side. Above the substrate 339, a printing device 363, a bar coating device 364, a first drying device 365, a developing device 366, and a second drying device 367 are disposed sequentially toward the winding roller 362 side from the delivery roller 361 side.

Below the substrate 339, the exposure apparatus 358 is disposed. The printing device 363 is intended for printing the light shielding section 340 made of a black resin on the substrate 339. The bar coating device 364 is intended for applying a transparent negative resist, in which a large number of light scattering bodies 69 such as glass beads are dispersed, on the light shielding section 340.

The first drying device 365 is intended for drying the transparent negative resist which is applied to form a coating film 348. The developing device 366 is intended for developing the transparent negative resist which is exposed with a developing solution. The second drying device 367 is intended for drying the substrate 339 in which the light transmission section 344 made of the transparent negative resist which is developed is formed.

The exposure apparatus 358 is intended for exposing the coating films 348 of the transparent negative resist, in which a large number of light scattering bodies 69 such as glass beads are dispersed, from the substrate 339 side. As shown in FIG. 40, the exposure apparatus 358 includes a plurality of light sources 359. In the plurality of light sources 359, the strength of the diffusion light F may be changed like that the strength of the diffusion light F from each light source 359 is gradually weakened, as the substrate 339 moves.

Alternatively, in the plurality of light sources 359, as the substrate 339 moves, the emission angle of the diffusion light F from each light source 359 may vary. By using such an exposure apparatus 358, it is possible to control the inclination angle of the side surface 344c of the light transmission section 344 to a desired angle.

According to the manufacturing apparatus of the viewing angle widening film (light diffusion member) of the present embodiment, since the light shielding section 340 is formed by the printing method, it is possible to reduce a use amount of the material of a black resin. In addition, the light transmission section 344 is formed in a self-aligned manner by using the light shielding section 340 as a mask, a precise alignment operation is not required and it is possible to shorten the time required for manufacturing. Considering the whole manufacturing process, since the light diffusion sheet is manufacture by a roll-to-roll method, it is possible to provide a method for producing of high throughput and low cost.

Further, although a liquid resist is applied in forming the light shielding section 340 and the light transmission section 344 in the above example, instead of this configuration, a film-like resist may be affixed to one surface of the substrate 339.

Hitherto, although an example of the present invention has been described through some embodiments, the technical scope of the embodiments of the present invention is not limited to the above embodiments, and various modifications are possible without departing from the scope of the embodiments of the present invention. For example, in the above embodiments, an example of the light diffusion section of a single-layer structure is described in the above embodiment, but a light diffusion section of a plurality of layers each of which is made of a material having different light-curing properties may be provided. In this case, it is possible to disperse light scattering bodies in each layer, or to disperse light scattering bodies in a specific layer.

In the above embodiments, a display body is used an example of a liquid crystal display device, but not limited thereto, an aspect of the present invention may be applied to organic electroluminescent display devices, plasma displays, or the like.

Further, in the above embodiment, an example is shown in which the viewing angle widening film is adhered to the second polarizing plate of the liquid crystal display body, but the viewing angle widening film and the liquid crystal display body may not be in contact necessarily.

For example, other optical films, other optical components, or the like may be inserted between the viewing angle widening film and the liquid crystal display body. Alternatively, the viewing angle widening film and the liquid crystal display body may be in a position in which they are apart from each other. Further, in a case of an organic electroluminescent display device, a plasma display, or the like, a polarizing plate is not needed, so the viewing angle widening film and the polarizing plate are not in contact with each other.

Further, it may be configured such that at least one of an anti-reflection layer, a polarizing filter layer, an antistatic layer, an anti-glare processing layer, and an antifouling processing layer is provided in the viewing side of the substrate of the viewing angle widening film in the above embodiments. According to the configuration, a function of reducing the reflection of external light, a function of preventing the adhesion of dirt and dust, a function of preventing scratches, or the like can be added depending on the type of the layer provided on the viewing side of the substrate. It is possible to prevent the aging of the viewing angle characteristics.

Further, although the light diffusion sections have a shape of being symmetrical with respect to the central axis in the above embodiments, the shape may not be necessarily symmetrical. For example, when an asymmetry angular distribution is required intentionally according to the usage and application of the display device, and for example, when there is a request such as the expansion of the viewing angle of only the upper side or only the right side of the screen, the inclination angle of the side surface of the light diffusion section may be asymmetrical.

Others, specific configurations regarding the arrangements and the shapes of the light diffusion section and the light shielding layer, the dimension and material of each portion of the viewing angle widening film, manufacturing conditions in the manufacturing process, or the like are not limited to the above embodiments, and can be appropriately changed.

### INDUSTRIAL APPLICABILITY

The aspect of the present invention may be used in various display devices such as liquid crystal display devices, organic electroluminescent display devices, and plasma displays.

### REFERENCE SIGNS LIST

1 . . . liquid crystal display device (display device),
2 . . . backlight (light source),
4 . . . liquid crystal panel (light modulation element),
6 . . . liquid crystal display body (display body),
7 . . . viewing angle widening film (light diffusion member, viewing angle widening member),
39 . . . substrate,
40 . . . light diffusion section,
41 . . . light shielding layer,
42 . . . light scattering body

1. A light diffusion member comprising:
a light transmissive substrate;
a plurality of light diffusion sections disposed in first regions on one surface of the substrate;
a light shielding layer disposed in a second region which is other than the first regions on the one surface of the substrate; and
a bonding layer disposed so as to overlap with the plurality of light diffusion sections,
wherein each of the light diffusion sections is formed such that one surface side of the substrate forms a light emitting end surface, a surface facing the light emitting end surface forms a light incident end surface, and a cross-sectional area of each of the light diffusion sections is increased from the light emitting end surface toward the light incident end surface, and
wherein a plurality of light scattering bodies are dispersively disposed in at least one side among the light diffusion sections and the bonding layer, each light scattering body being formed of a material having a refractive index which is different from a refractive index of a constituent material of the light diffusion sections or a constituent material of the bonding layer.

2. The light diffusion member according to claim 1,
wherein the light diffusion sections are formed such that the dimension thereof between the light emitting end surface and the light incident end surface is larger than the thickness of the light shielding layer.

3. The light diffusion member according to claim 1,
wherein the plurality of light diffusion sections are arranged in stripes at a distance from one another as viewed from a normal direction of the one surface of the substrate, and
wherein the light shielding layer is disposed as a stripe between the light diffusion sections arranged in stripes at a distance from one another as viewed from the normal direction of the one surface of the substrate.

4. The light diffusion member according to claim 3,
wherein at least one of the dimension of the plurality of light diffusion sections in a lateral direction and the dimension of the light shielding layers in a lateral direction are set randomly.

5. The light diffusion member according to claim 1,
wherein the plurality of light diffusion sections are scatteringly disposed on the one surface of the substrate, and
wherein the light shielding layer is formed continuously in the second region.

6. The light diffusion member according to claim 5,
wherein the plurality of light diffusion sections have the same cross-sectional shape to each other and are regularly arranged on the one surface of the substrate.

7. The light diffusion member according to claim 5,
wherein the plurality of light diffusion sections have the same cross-sectional shape to each other and are irregularly scattered on the one surface of the substrate.

8. The light diffusion member according to claim 5,
wherein the plurality of light diffusion sections have cross-sectional shapes of different types from each other and are irregularly scattered on the one surface of the substrate.

9. The light diffusion member according to claim 1,
wherein cross-sectional shapes of the plurality of light diffusion sections are circular, elliptical, and polygonal.

10. A light diffusion member comprising:
a light transmissive substrate;
a plurality of light shielding layers disposed in first regions on one surface of the substrate; and
a light diffusion section disposed in a second region which is other than the first regions on the one surface of the substrate,
wherein the light diffusion section is formed such that one surface side of the substrate forms a light emitting end surface, a surface facing the light emitting end surface forms a light incident end surface, and the dimension of the light diffusion section between the light emitting end surface and the light incident end surface is larger than the thickness of the light shielding layers,
wherein hollow portions are formed in formation regions of the light shielding layers, a sectional area of each hollow portion decreasing in a direction away from the light shielding layers, and each hollow portion being partitioned by a formation region of the light diffusion section, and
wherein a plurality of light scattering bodies are dispersively disposed in the light diffusion section, each light scattering body being formed of a material having a refractive index which is different from a refractive index of a constituent material of the light diffusion section.

11. The light diffusion member according to claim 10,
wherein the plurality of light shielding layers are scatteringly disposed on the one surface of the substrate, and
wherein the light diffusion section is formed continuously so as to surround the light shielding layers.

12. The light diffusion member according to claim 11,
wherein the hollow portions have the same cross-sectional shape to each other and are regularly arranged on the one surface of the substrate.

13. The light diffusion member according to claim 11,
wherein the hollow portions have the same cross-sectional shape to each other and are irregularly scattered on the one surface of the substrate.

14. The light diffusion member according to claim 11,
wherein the hollow portions have cross-sectional shapes of a plurality of different types from each other and are irregularly scattered on the one surface of the substrate.

15. A display device comprising:
the light diffusion member according to claim 1; and
a display body which is bonded to the light diffusion member through the bonding layer.

16. The display device according to claim 15,
wherein the display body includes a plurality of pixels forming a display image, and
wherein the light diffusion sections are disposed such that a maximum pitch between the light diffusion sections which are adjacent to each other is smaller than the pitch between the pixels of the display body.

17. The display device according to claim 15,
wherein the display body includes a light source and an optical modulation element which modulates light from the light source, and
wherein the light source emits light having directivity.

18. The display device according to claim 15,
wherein the display body is a liquid crystal display element.

19. A method for producing a light diffusion member, comprising:
forming a light shielding layer on a substrate;
forming openings, through which the substrate is exposed, in the light shielding layer; and
forming, for the openings, a light diffusion section in which a plurality of light scattering bodies are dispersively disposed by using the light shielding layer as a mask.

20. The method for producing a light diffusion member according to claim 19,
wherein any one of black resins, black inks, metals, or multilayer films including metals and metal oxides is used as the light shielding layer.
